(19) United States
(12) Patent Application Publication
(10) Pub. No.: US 2007/0189520 A1
(43) Pub. Date: Aug. 16, 2007

(54) Systems and Methods to Facilitate Transition from Communication to Commerce

(75) Inventors: Ebbe ALTBERG, Mill Valley, CA (US); Scott FABER, San Francisco, CA (US); Ron HIRSON, San Francisco, CA (US); Sean VAN DER LINDEN, Berkeley, CA (US); Paul G. MANCA, Oakland, CA (US); Amit AKHOURI, Fremont, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: UTBK, INC., Dover, DE (US)

(21) Appl. No.: 11/696,153

(22) Filed: Apr. 3, 2007

Related U.S. Application Data
(63) Continuation-in-part of application No. 11/329,459, filed on Jan. 10, 2006.
(60) Provisional application No. 60/799,610, filed on May 10, 2006.
(60) Provisional application No. 60/888,937, filed on Feb. 8, 2007.

(51) Int. Cl. H04L 9/30

(52) U.S. Cl. 380/30

(57) ABSTRACT

A method and system to facilitate the conversion from communications to commerce. In one embodiment, a method includes: establishing a communication session between a first user and a second user; facilitating communications between the first user and the second user for a first period of time of the communication session; after the first period of time, receiving from the first user a request to charge the second user during the communication session; responsive to the request received from the first user, prompting the second user to accept a price to continue the communication session; and responsive to a response from the second user, charging the second user according to the price for a second period of time of the communication session.

### CROSS-REFERENCE TO RELATED APPLICATIONS

This application is a continuation-in-part of co-pending U.S. patent application Ser. No. 11/329,459, entitled “Systems and methods to provide availability indication” and filed on Jan. 10, 2006. The present application claims priority to Provisional U.S. patent application Ser. No. 60/799,610, filed on May 10, 2006 and entitled “Systems and methods to convert a free call to a fee-based call,” and Provisional U.S. patent application Ser. No. 60/888,937, filed on Feb. 8, 2007 and entitled “Systems and Methods to Facilitate Transition from Communication to Commerce”. The disclosures of the prior applications are hereby incorporated herein by reference.

### TECHNICAL FIELD

At least some embodiments of the disclosure relate generally to user interface techniques that assist people with connecting for real-time communication, such as connecting people for telephonic conversation, chat, document sharing, screen-sharing, etc.

### BACKGROUND

The Internet, cellular communication systems, television, newspaper, etc., provide diverse communication media channels through which people may receive information and/or communicate with one another.

People may use a web site to chronologically publish personal thoughts and web links. Such a web site may be referred to as a blog. A blog may include content showing what is happening in the life of the person, collecting information on certain types of subjects of interest to the person, providing links to related web sites, etc. Thus, a personal web site may include a collection of contents that may be helpful to people of similar interest.

Telephone systems allow users to conduct real time two-way voice communication. Traditional land-line based telephone systems connect one telephone set to another through one or more switching centers, operated by one or more telephone companies, over a land-line based telephone network. Traditionally, a telephone connection is based on a circuit switched network.

Current telephone systems may also use a packet-switched network for a telephone connection. A packet switched network is typical in a computer data environment. Recent developments in the field of Voice over IP (VoIP) allow the delivery of voice information using the Internet Protocol, in which voice information is packaged in a digital form in discrete packets rather than in the traditional circuit-committed protocols of the public switched telephone network (PSTN).

Cellular networks allow a cellular phone to connect to a nearby cellular base station through an air interface for wireless access to a telephone network. Recent developments in wireless telephone systems allow not only voice communications but also data communications. For example, cellular phones can now receive and send short messages through a Short Message Service (SMS). Web pages can now be retrieved through wireless cellular links and displayed on cellular phones. Wireless Application Protocol (WAP) has been developed to overcome the constraints of relatively slow and intermittent nature of wireless links to access information similar or identical to World Wide Web.

### SUMMARY

Methods and systems to facilitate the conversion from communications to commerce are described herein. Some embodiments are summarized in this section.

In one embodiment, a method includes: establishing a communication session between a first user and a second user; facilitating communications between the first user and the second user for a first period of time of the communication session; after the first period of time, receiving from the first user a request to charge the second user during the communication session; responsive to the request received from the first user, prompting the second user to accept a price to continue the communication session; and responsive to a response from the second user, charging the second user according to the price for a second period of time of the communication session.

The present disclosure includes methods and apparatuses which perform these methods, including data processing systems which perform these methods, and computer readable media which when executed on data processing systems cause the systems to perform these methods.

Other advantages of the invention are described below.

### BRIEF DESCRIPTION OF THE DRAWINGS

The present invention is illustrated by way of example and not limitation in the figures of the accompanying drawings in which like references indicate similar elements.

FIG. 1 illustrates a system according to one embodiment of the present invention.

FIG. 2 illustrates a user interface to create a listing according to one embodiment of the present invention.

FIG. 3 illustrates a user interface to start a communication according to one embodiment of the present invention.

FIG. 4 illustrates a user interface to display the status of a communication connection process and to provide the user guidance through the process according to one embodiment of the present invention.

FIGS. 5-12 show examples of flow diagrams of a process to connect a user and an adviser for communication according to one embodiment of the present invention.

FIG. 13 illustrates a method to display a call button according to one embodiment of the present invention.

FIG. 14 illustrates a method to monitor and control a connection according to one embodiment of the present invention.

FIG. 15 shows a diagram of a system to assist and track connections according to one embodiment of the present invention.

FIG. 16 shows a block diagram example of a data processing system which may be used with the present invention.

FIG. 17 illustrates a user interface to create a listing according to one embodiment of the present invention.

FIG. 18 shows an example of a flow diagram of a process to connect a user and an adviser for communication according to one embodiment of the present invention.

FIG. 19 shows another example of a flow diagram of a process to connect a user and an adviser for real time communication according to one embodiment of the present invention.

FIG. 20 shows a system including a connection server configured on a packet switched network according to one embodiment.

FIG. 21 shows a connection server according to one embodiment.

FIGS. 22-30 illustrate examples of providing connections for real time, in person communications and facilitating commerce over the communication connections according to one embodiment.

FIG. 31 illustrates examples of multimedia communication connections according to one embodiment.

FIG. 32 illustrates a call graphic that allows a user to monitor concurrent connections according to one embodiment.

FIG. 33 illustrates a method to facilitate commerce over communication connections according to one embodiment.

### DETAILED DESCRIPTION

A method and system for converting a free call to a fee-based call are described. In the following description, for purposes of explanation, numerous specific details are set forth in order to provide a thorough understanding of the present invention. It will be evident to one skilled in the art, however, that the present invention may be practiced without these specific details. The description and representation herein are the means used by those experienced or skilled in the art to effectively convey the substance of their work to others skilled in the art. In some instances, to avoid unnecessarily obscuring aspects of the present invention, well-known operations and components have not been described in detail.

Reference herein to “one embodiment” or “an embodiment” means that a particular feature, structure, operation, or other characteristic described in connection with the embodiment may be included in at least one implementation of the invention. However, the appearance of the phrase “in one embodiment” or “in an embodiment” in various places in the specification does not necessarily refer to the same embodiment.

In one embodiment of the present invention, a system is to provide services to people who wish to make connections for real time communication, such as live telephone conversation, chat, video conferencing, instant messaging, and other forms of real time communications.

For example, benefits of the services may include anonymity for one or more of the parties of the real time communication. For example, the service can connect the caller and callee without revealing the contact information of one party to another, such as the actual telephone number. The services may include filtering callers/participants so that only those who are willing to pay can get connected. The services may include collecting payments for the callee so that the callee can earn money from talking to the callers over the phone without the burden of managing payment collection, etc. The services may include scheduling so that the real time communication are initiated at a convenient time (e.g., no night calls). The services may include queue managing to serve both the callees and the callers. The services may include providing the cool, convenient click-to-call functionality to attract callers for the callees.

In one embodiment, the services may include providing a persistent and consistent way to reach people. For example, a web link, or a toll-free number, or a local phone number can be provided by the system so that the callers can reach the callee using the web link, or the toll-free number, or the local phone number even after the telephone of the callee has been changed. The callee can publish the web link and/or the phone number, knowing that the calls will follow if the callee updates the telephone number in the system. The callees do not need to reveal their actual telephone numbers to the potential callers. If desired, the callee can keep the caller from knowing the actual telephone number of the callee for anonymity.

In general, the service may provide any combination of the benefits discussed above.

Many examples are presented in the context of telephone connection for real time conversation. Embodiments of the present invention can also be applied to other real time communication systems (e.g., text chat, instant messaging, voice/video conferencing, etc.) in a way similar to the telephone conversation.

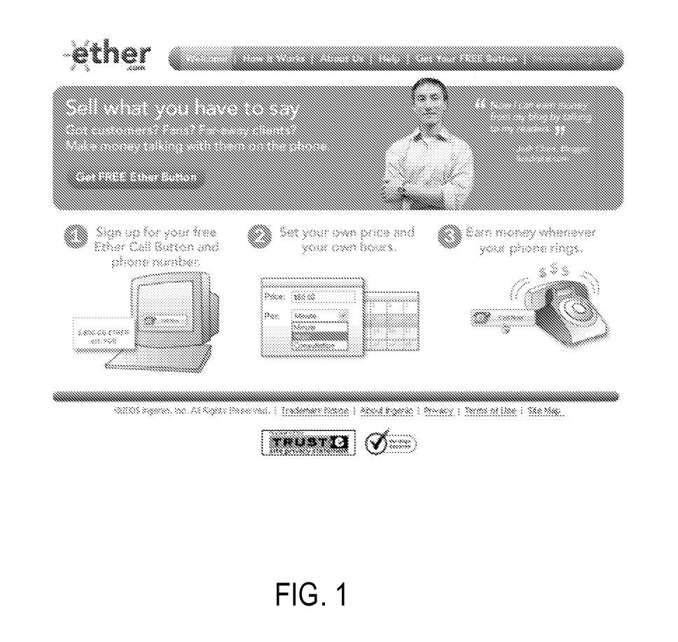

FIG. 1 illustrates a system according to one embodiment of the present invention. As illustrated in FIG. 1, callees who have customers, fans, far-away clients, etc., can make money talking with them on the phone. The system provides the callees with services of managing the transactions such that the callees can sell what they have to say with reduced/minimum efforts on business aspects. For example, a blogger can earn money from the blog by talking to the interested readers of the blog.

In one embodiment, the callee can sign up for a call button of the system and/or for a phone number provided by the system. The call button and/or the assigned phone number can be used as the contact information of the callee. For example, the callee can publish the call button and/or the phone number in a variety of media channels and environments, such as in the blog, in advertisements, in news articles, in column discussions, in business cards, etc.

In one embodiment of the present invention, the callees manage their own distribution of the call button and/or the phone number, since the callees may have their unique ways to reach potential callers (e.g., through blogs, home pages, business cards, etc.). The callees can bring the call button and/or the phone number into the context where the customers of the callees are, such as their own web pages or blogs or business cards (e.g., via a phone number).

Alternative, or in combination, the system may also help the callees to reach callers through presenting the call buttons and/or the phone numbers in marketplaces, such as online listings of services, advertisements embedded in the search results generated by a search engine, classified advertisements, etc.

After signing up for the call button and/or the phone number, the callees can set up their own prices and their own hours for receiving the calls. When the call button and/or the phone number leads the callers to callees, the callees can earn money by talking to the callers without having to manage scheduling, queue, payment collection, privacy, etc. For example, the callees can enjoy the benefit of anonymity provided by the system, since the callees do not have to reveal their actual phone numbers to the potential callers in order to receive calls. The system provides the filtering functionality so that some callers can reach the callees.

In one embodiment of the present invention, the services of the system are packaged and delivered through the use of a call button and/or a communication reference (such as a phone number) assigned to the callee. The callees do not have to rely upon a marketplace, such as keen.com, to reach callers.

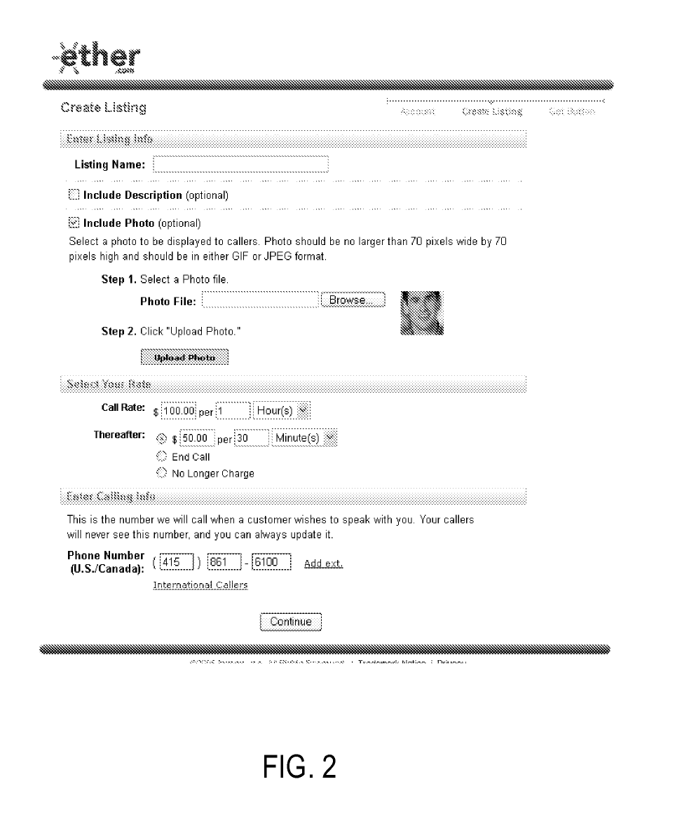

FIG. 2 illustrates a user interface to create a listing according to one embodiment of the present invention. In FIG. 2, the callee can specify the rate the callee will charge the callers when the callers want to talk to the callee.

In one embodiment, the callee may specify the price (rate) in terms of a package, such as $100 for one hour. A call package has a specified price for a given time limit that is longer than one minute (e.g., one hour). Alternatively, the callee may specify the price in terms of a price per unit of time, such as $2 per minute, without specifying a time limit.

In one embodiment, when the rate is specified as a package that includes a time limit (e.g., 60 minutes, two hours, etc.), the callee can further specify the policy for the continuation of the call beyond the time limit (e.g., $50 per 30 minutes thereafter, or end call, or no longer charge).

In the user interface illustrated in FIG. 2, the callee can specify the phone number (e.g., 415-861-6100) at which the system will call the callee when a customer wishes to speak to the callee. The phone number is used by the system to call the callee and make a connection to the customer. The phone number of the callee is not provided to callers (customers of the callee) for anonymity.

In one embodiment, the callee may specify a listing name (e.g., for this listing). The callee may create multiple listings with different rates, phone numbers, etc., in the same account. Optionally, the callee provide may further description and a photo (e.g., a photo of the callee) for the listing.

In one embodiment, the photo of the listing should be no larger than 70 pixel wide by 70 pixel high and should be in either GIF or JPEG format. Alternatively, the system may automatically convert the image uploaded from the callee into the appropriate size and format. However, it is understood that other sizes can also be used.

After the listing is created, the callee can select the button “Continue” to access the next screen for getting the call button.

In one embodiment, the web server of the system provides the callee with: a call button and/or a phone number, such as 1-800-GO-ETHER extension XXXX, after the callee finishes creating the listing. The call button and the phone number assigned to the callee are intended for the callee to place wherever a caller (buyer) will come across them.

For example, a golf pro provides great swing tips. The golf pro as a callee (seller) can put a call button on a blog, on a web page, in the footer of an email, etc. When people are reading the blog about golf equipment, they might think “I'm really interested in what this person has to say, I think I'll pay to talk to them live and ask them all my questions.”

In one embodiment, the call button includes HTML (Hypertext Markup Language) code which contains a reference to the listing and one or more links to a server of the system. The HTML code can be inserted into the blog and/or the home page of the callee, or an email. When the HTML code is rendered in the browser of the caller (e.g., when the caller visits the blog or the home page of the callee, or when the caller views an email from the callee), the browser shows a call button which can be selected (e.g., through “clicking” on the call button using a cursor controlling device, such as a mouse, a track ball, a joystick, a touch screen, etc.) to request a phone connection. An example of the appearance of a call button includes an icon showing a telephone set and the text “call now”, as illustrated in FIG. 1.

In one embodiment, when the call button is rendered, the appearance of the call button may include an icon, which when selected or activated can initiated a request for a real time communication connection.

Alternative, the call button can be specified in documents in a format other than HTML, such as in an extensible markup language (XML).

In one embodiment, the call button can change its state depending on the state of the caller and/or callee. For instance, if the callee is already on a phone call with a caller, the button would indicate “busy,” so that a second caller would see that the callee is already on a telephone. Clicking on the button in this instance would give the second caller the ability to get in line to talk to the callee. Or, in another embodiment, the second caller clicking on the button could give him the ability to join the call in progress.

In one embodiment, the call button can change its state depending on what the callee explicitly indicates. The callee could, for instance, tell the system, via a web form or telephone IVR, that he is currently “taking calls” or “not taking calls” or “offering video” or “offering chat” or “taking appointments” or taking “arranged calls” or “callbacks.” He could indicate that he is taking calls and is “by my phone,” indicating a heightened presence. Depending upon each of such states, the system would lead callers down different communication paths. If a callee is “by my [his/her] phone,” the system might call the caller first, since it's highly probably that the callee will be available for his/her side of the connection. If the callee is simply “taking calls,” the system might call the callee first, since he/she might be the more unlikely party to be available. Other communication paths include getting in line, joining a conference call, turning on a video connection, scheduling an appointment, entering into a chat session, etc.

Similarly, the golf pro can use the phone number for various offline media and other media. For example, if the golf pro writes a column for Golf Digest magazine, he can put the phone number that is assigned to him (e.g., Ether phone number) at the end of the column, such as 1-800-GO-ETHER, extension XXXX. The system can even provide him with a custom 800 number, such as 1-800-GOLF-PRO, rather than the extension to a generic 1-800-GO-ETHER number. For example, the column may include the following message: “Call me to talk about your own golf swing. Dial 1-800-GOLF-PRO. $100/hour.” Alternatively, the Ether phone number can be a phone number local to a specific region of interest to the golf pro (e.g., having the same area code, or the same area code and exchange, as those in the target geographical area).

In one embodiment, the callee may request a phone number, such as “1-800-GO-ETHER” extension “YOU”, which is specifically assigned to the callee (and/or the listing). The callee can publish the assigned phone number in the blog, home page, printed publications, brochure, or business card. The phone number may be given out during a TV or radio talk show, etc. When the assigned phone number is called, the call is first connected to a server of the system. The system can then call the callee and join the caller and the callee for real time communication.

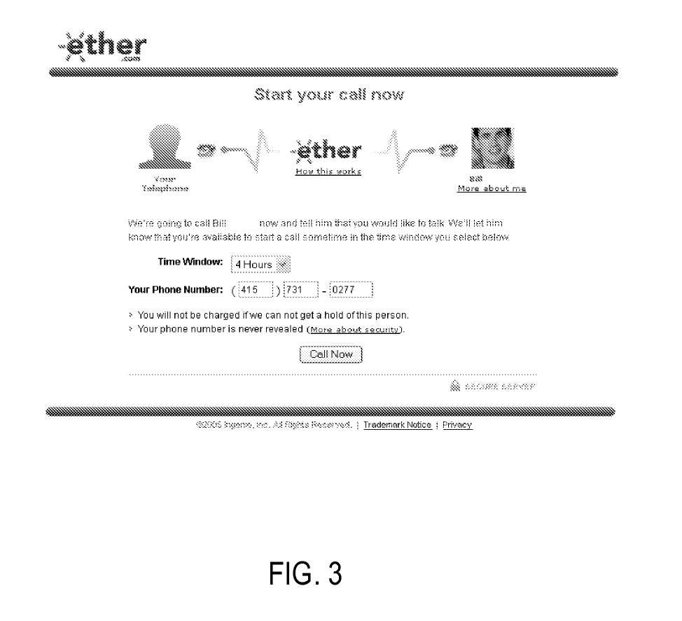

FIG. 3 illustrates a user interface to start a communication according to one embodiment of the present invention. For example, after a caller selects a call button, the user interface as illustrated in FIG. 3 is displayed (e.g., in the browser of the caller, or in a pop-up window).

In the example of FIG. 3, a call graphic is displayed to show the progress of making the connection. In FIG. 3, the photo of the callee (e.g., the photo uploaded by the callee to the server for the listing during the creation of the listing) is displayed with a link “More about me”, which when selected causes the browser to display the description of the listing corresponding to the call button.

In one embodiment, when the photo of the listing is not available, the system may present a standard icon to represent the callee.

In FIG. 3, an icon and the description “Your Telephone” are displayed to present the caller. An “ether” icon between the caller and callee represents the system. The link “How this works” under the “ether” icon can be selected to see the details of the call process, which can be helpful to a user who is not familiar with the system.

The user interface presents an entry to receive a time window (e.g., 4 hours) within which the caller is available to take a call back from the system to talk to the callee. The user interface also includes an entry to receive the phone number of the caller such that the system can call back the caller to make the connection between the caller and the callee in this time window.

In one embodiment, the user interface can be part of the VoIP client application (e.g., the user interface of a VoIP terminal, such as the user interface of a VoIP-enable phone, or an application window of a VoIP application running on a computer or a Personal Digital Assistant (PDA)). The VoIP phone connection can be established, whether the user inputs the callback phone number or if the VoIP connection simply connects the two parties without the need of a phone number.

In FIG. 3, the user interface includes a button “call now” which when selected causes the user interface to send the time window and the callback phone number to a server to request for a phone connection.

In one embodiment, the user interface is part of the VoIP client application which can send the telephonic contact information (e.g., the phone number of the VoIP client application or a user ID of the VoIP system) to the server without the user explicitly specifying the call back number.

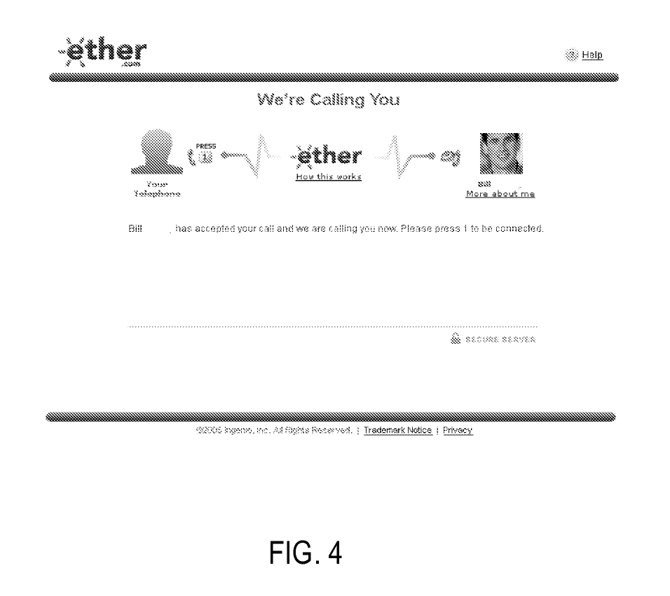

FIG. 4 illustrates a user interface to display the status of a communication connection process and to provide the user guidance through the process according to one embodiment of the present invention.

In FIG. 4, the call graphic shows that the phone of the callee is off the hook, indicating that the callee has accept the call. The call graphic shows the icon “Press 1” to instruct the caller to press “1” on the phone to be connected to the callee.

The user interface further provides text explaining the status and instruction to the caller.

In one embodiment, before the callee accepts the call, the system calls the callee, during which the call graphic shows that the phone of the callee is ringing and the phone of the caller is on the hook, not yet answered by the callee. The text is provided in the user interface to explain the current status of the connection process and to instruct the user to wait while the system is contacting the callee.

Thus, in one embodiment, the system provides the user-friendly, step-by-step feedback and instruction to the caller to guide the caller through the connection process.

In one embodiment, after the connection between the caller and callee is established, the system further provides feedback and instructions on the call graphic. For example, during the call the system can provide the accumulated call time for the purchased call. If the purchased call has a time limit, the call graphic can further show the remaining minutes of the call. When the time limit is approaching (or reached), the call graphic can provide the guidance and instructions for “recharge” (e.g., by purchasing a further package, or switching to a per minute mode with a further time limit, etc.). In one embodiment, the options to continue the call when the time limit is approaching (or reached) is displayed in the graphical user interface so that the caller may select an option in the graphical user interface without interrupting the conversation with the callee.

In one embodiment, if a purchased call with a time limit is interrupted/dropped before the time limit is reached, the caller can continue the call by requesting a re-connection with a time window. To help the caller, the call graphic can present the guidance and instructions for continue the call and present the status of the continuation of the call. For example, the call graphic may present a description of the continuation policy for interrupted/dropped call and show the remaining portion of the time window to resume the call.

One example scenario of using a call button that is placed in the blog, home page, or email of the callee (seller) is described below.

When the callee (seller) is taking calls, the call button of the callee (seller) says “Call Me.”

When the caller (buyer) clicks on the button, the caller (buyer) is led to a landing page that explains how the service works and indicates the price, which might be $100 to talk on the phone for 60 minutes and $1 per minute thereafter.

When the caller (buyer) clicks the “Continue” button on the landing page, the caller (buyer) is brought to a page to specify payment options (e.g., credit card information). Or, if the caller (buyer) is a returning member, the caller (buyer) can sign in (e.g., through providing the correct member name and password) to instruct the system to use the billing information (e.g., credit card and billing address) that is already on file (e.g., that has been previously submitted to the system and that is stored in the database of the system in association with account of the caller). If the caller (buyer) is not a member, the caller (buyer) is presented with a page to register with the system and become a member. Alternatively, the caller (buyer) may specify the payment information without becoming a member.

For example, the page may identify the caller (buyer) as a member according to the information provided by a cookie maintained by the web browser of the caller (buyer). If the cookie exists, the cookie includes the member name of the caller (buyer). If the cookie indicates that the caller (buyer) has already signed in, the server may skip the sign-in process; otherwise, the caller (buyer) is prompt to sign in. If the caller (buyer) is new to the network, the caller (buyer) is asked to register and become a member.

In one embodiment of the present invention, the call button/link does not bring the caller (buyer) inside the marketplace (e.g., a list showing competitors). Instead, the actions related to the call button happen in the environment of the callee (seller). For example, the web page(s) can be just a pop-up window so that the caller does not have to leave the web page (e.g., blog or home page) of the callee (seller). The landing page may be within a frame of the blog/home page of the callee, or within an applet embedded in the blog/home page of the callee.

Alternatively, the call button may bring the caller (buyer) to a VoIP application and provide the guidance and instruction to the caller on the user interface of the VoIP application.

In one embodiment, the VoIP application has browser functionality and shows the call button with the blog, web page or email in the user interface of the VoIP application.

Alternatively, the call button may bring the caller (buyer) to the marketplace which shows the offers of the competitors of the callee (seller).

In one embodiment, after confirming the payment information, the caller (buyer) is led to a page to specify the phone number that the caller (buyer) would like to be called back at and the time window within which the caller (buyer) is willing to receive the call back to talk to the callee (seller). The time window might be “four hours.” FIG. 3 shows an example of such a page.

When the caller (buyer) continues (e.g., pressing the button “Call Now” in FIG. 3), the system obtains the authorization to charge an amount, when the call is connected (e.g., $100 from the buyer's credit card, if the credit card is the method of payment).

In one embodiment, a call for a package of bulk minutes (e.g., that has a specified time limit) is charged when the two parties are connected, regardless of whether the duration of the time limit is reached. In one embodiment, to avoid the difficulty in charging the buyer (e.g., $100) to talk to a seller but the seller fails to call back within the time window requested by the buyer, the system does not charge the buyer until after a connection between the caller (buyer) and the callee (seller) is successfully established (e.g., for a minimum period of time, or after the phone call is completed, or after the time limit is reached, etc.).

In one embodiment, the system “pre-authorizes” the charge (e.g., $100) on the buyer's credit card to make sure that, should the connection be completed, the buyer would be able to pay. In one embodiment, the system indicates the status of pre-authorization, charging/not-charging to the buyer in the user interface that guides the user through the process of making the connection.

Alternatively, the system may make the charge (e.g., $100) on the buyer's credit card when starting to make the connection and make a refund to the buyer if the connection is not successful within the call back time window specified by the caller (buyer). Alternatively, the system may charge a portion of the fee (e.g., $100) during the phone connection set up period, and refund the charge if the connection is not successful or charge the remaining portion after the connection is made successfully (e.g., after the phone call is completed).

In one embodiment, the system determines whether or not to pre-charge the buyer based on statistical data, such as the credit history of the caller (buyer), the success rate of the callee (seller) to call back within the time window specified by the caller (buyer), etc. Thus, for example, if the system determines that the call is likely to be established within the time window, the system may pre-charge the caller; for example, if the system determines that the caller (buyer) has a good credit history, the system may defer the charge to a later stage (e.g., after the completion of the call).

In one embodiment, after the system determines that the caller (buyer) has a sufficient source to pay for the call, the system calls the callee (seller) and says: “We have a caller who is calling you on your call button. He is paying your $100 fee and is willing to wait up to 4 hours to talk to you. Please press 1 on your telephone keypad if you want to take the call now; press 2 if you can't take it now but can indeed take it within the next 4 hours that has been requested, or press 3 if you won't be able to take it within 4 hours.” Note that different system may associate different sets of key pressing events (e.g., press 1, press 2, press 3, . . . ) with different options.

In one embodiment, the system can optionally provide the callee (seller) with more information about the caller (buyer) based on pre-recorded information. For example, the system can record the self introduction of the caller (buyer) (e.g., the name of the caller, for instance ‘Bob’) so that the system tells the callee “We have ‘Bob’ . . . ” instead of “We have a caller . . . ”, where ‘Bob’ is the recording of the self-introduction of the callee (buyer).

In one embodiment, the system has the name of caller (buyer) recorded as part of the member preference/attribute of the caller (buyer). Alternatively, the system can use a text-to-speech program to “read out” the name of the buyer when introducing the call to the callee (seller). Alternatively, the system can record the name of the caller (buyer) when the system receives a call from the caller at the phone number assigned to the callee, or callback the caller first to obtain the recording.

In one embodiment, if the callee (seller) presses 1, the system tells the callee (seller) to hold on while the system calls the caller (buyer). The screen of the caller (buyer) is updated automatically to indicate that the callee (seller) is ready and the caller (buyer) is being called back for the connection between the caller (buyer) and the callee (seller).

If the callee (seller) presses 2, the system tells the caller (buyer) (e.g., on the screen of the caller) that the callee (seller) can't take the call now but expect to take the call within an identified period of time (e.g., the next 4 hours). The system will arrange to make the phone connection within the identified period of time (e.g., the next 4 hours).

In one embodiment, the system may use alternative numbers to indicate a response of the callee.

For example, the system may send a message (e.g., through email, a web-based user interface for the callee (seller), a voice mail, an instant message, etc) to the callee about the call and the identified period of time (e.g., 4-hour time window) so that the callee (seller) may indicate to the system within the identified period of time (e.g., next 4 hours) that the callee (seller) is ready for the call.

Alternatively, the system may try to call the callee (seller) periodically or according to a time period specified by the callee (seller). For example, the callee may press 15 after pressing 2 to indicate that system should try to make the connection after 15 minutes. Alternatively, the callee may provide such an indication through replying to the email, instant message, short text message, or through a network-based user interface (e.g., web-based) that is designed to manage the user account. For example, the network-based user interface may present a list of calls in the queue and the corresponding time windows. When ready to take the next phone call, the callee can indicate to the system that the callee is currently available to take a call (or a particular one of the calls in the list).

Alternatively, the caller (buyer) may try to call the callee (seller) again within the time window (e.g., next 4 hours).

In one embodiment, the system may monitor the activities related to this call to avoid duplicated efforts in making the connection within the time window (e.g., next 4 hours) so that the caller and callee are not interrupted by unnecessary attempts to make the connection.

If the callee (seller) presses 3, the system tells the caller (buyer) that the callee (seller) can't take the call within the requested time window. The caller (buyer) in this case is not charged the price (e.g., $100). In one embodiment, the caller (buyer) is charged the price (e.g., $100) only when the call between the caller (buyer) and callee (seller) is actually connected.

When the system makes the connection between the caller (buyer) and callee (seller), the system may call the caller (buyer) first or call the callee (seller) first, or call both at about the same time. For example, the system may determine which one of the caller and callee is more reliable and call the reliable one of the two first. The system may determine which of the parties is more reliable based on statistic data collected from past call connection activities. Alternatively, the system may connect to the less reliable party first. Alternatively, the callee (seller) may specify the preference of who is to be called first as part of the specification of the listing.

When the caller (buyer) calls the phone number assigned to the callee (assignee) (e.g., 800-GO-ETHER extension 4567), the system may first authenticate the caller and/or arrange the payment options and then prompt the caller to enter the time window and the call back phone number using the key pad of the phone. An interactive voice response (IVR) system can be used to interact with the caller so that the caller does not need web access to be connect to the callee (seller).

Alternatively, the system may determine automatically the telephone contact information of the caller from the call received from the caller (buyer) (e.g., through call ID service or an Automatic Number Identification (ANI) service) and use the telephone contact information in calling back. The system may present an option for the caller (buyer) to confirm the automatically detected telephone contact information of the caller for calling back so that the caller has an opportunity to specify different telephone contact information for the call back.

In one embodiment, when the system determines that the caller has a graphical user interface (e.g., web access) while requesting the connection for the call (e.g., when the caller pushes a button on a web interface to request the call, or when the caller is signed into the system or when the online presence of the caller is detected, or when the call is initiated from a VoIP terminal that has a graphics capability), the system uses the graphical user interface to assist the caller. When the system fails to detect the online presence of the caller, the system uses the IVR system to provide the caller (buyer) with guidance. Thus, the system automatically switches between using the web interface to guide the caller or using the IRV interface to guide the caller.

In one embodiment, the system may further use other communication systems to guide the callee (e.g., according to the presence and availability of such communication systems). For example, the interface may be Wireless Application Protocol based (WAP-based) applications, or based on instant messaging, or based on a custom designed client-server application/protocol. Thus, a web-based interface is presented as an example. User interfaces based on other communication protocols and/or other types of communication systems can also be used.

In one embodiment, the system may ask the caller (buyer) to hang up temporarily until the callee accepts the call. Alternatively, the system may allow the caller (buyer) to stay on the line while the system attempt to reach the callee (seller).

In one embodiment, the system allows the callee (seller) to specify one or more alternative phone numbers in case the callee (seller) is not reachable at the primary phone number specified for the listing. Similarly, the caller (buyer) may also specify one or more alternative call back phone numbers. In one embodiment, the system allows the parties to specify other telephonic references (e.g., user names of Internet telephonic application) to make the telephone connection. In one embodiment, the system may further allow the user to specify other identities to make connections for other types of real time communications, such as chat, instant messaging, video conferencing, etc.

In one embodiment, the system arranges the call according to aspects of the methods described in the U.S. Patent Application Publication No. 2004/0252820 (application Ser. No. 10/360,776, filed on Jun. 12, 2003), which is hereby incorporated herein by reference.

When the caller (buyer) requests the connection using the call button, the web server provides the instructions and feedback to guide the caller (buyer) through the call process.

When the caller (buyer) dials the callee's listing via the Ether phone number (e.g., the 800 number assigned to the callee), an interactive voice response (IVR) system is used to provide similar instructions and feedback to guide the caller (buyer) through the call process.

For example, the caller (buyer) registers and creates an identity using the phone number and a PIN. A credit card is asked for via IVR or live operator to set up payment options. Then the call window is entered on the keypad of the phone, such as pressing the string of keys “4*” to indicate a “4” hours window or “60#” for a “60” minutes window.

In one embodiment, when the callee is having a telephonic connection with the system, the system prompts the caller (buyer) to utter a message for the callee (seller). For example, the caller (buyer) may say “I'm Bob Stanley remember we met at the golf conference last weekend.” The system records the messages of the caller (buyer). When the callee (seller) gets the call, the system says, “There's a buyer on the line who's paid $100 and is willing to wait 4 hours and here's how he identifies himself: ‘I'm Bob Stanley remember we met at the golf conference last weekend.” The system in such a way provides as much identifying information to the callee (seller) as possible so that the callee (seller) may screen the callers for acceptance. In one embodiment, the system behaves as an automatic secretary, screening who's on the line for the callee (seller).

In one embodiment, the system provides functionality for bulk-minute pricing.

For example, once a call starts, the system metes out the time that has been bought. When the time limit, for example, 60 minutes, is up, the system tells both parties on the phone that the time is up. The system then prompts the buyer to add more money to buy a second package, or go to per minute pricing, or end the call, or let them talk further for free, according to the continuation policy of the call which is specified by the callee (seller) in the listing (e.g., specified during the creation of the listing).

In one embodiment, if the parties hang up after just, for example, 35, minutes of a 60-minute call, the system has a time window in which it expires the remaining minutes. The time window can be set quite large, such as a year, so that someone can buy a 1,000-minute discount package and talk 100 times over the course of the year. Or the time window can be set small, such as 30 minutes, in which case the caller (buyers) can call again within the 30-minute window after the 35-minute call to keep talking based on the already purchased 60-minute package, but the caller (buyers) can be connected on the basis of the unused portion of the 60-minute call package after a break that is longer than the time window.

In one embodiment, the system time window specifies the longest period of break before the unused portion of the purchased package expires.

In one embodiment, the system time window specifies the period from the starting of the conversation and the time when the purchased package expires. For example, the system may specify a window of 4 hours or so by default, so that people who get cut off or interrupted can finish their calls in this window of time.

In one embodiment, the system time window is based on the size of the purchased package. The larger the time limit of the package, the larger is the time window. In one embodiment, the expiration of the package is based on a limit on the separate calls (e.g., three). In one embodiment, the expiration of the package is based on the expiration time window and the limit on separate calls, whichever is reached first.

In one embodiment, the system allows the callee (seller) to specify the expiration time window in the specification of the listing (e.g., as part of the continuation policy of the call package) and/or the limit on the separate calls.

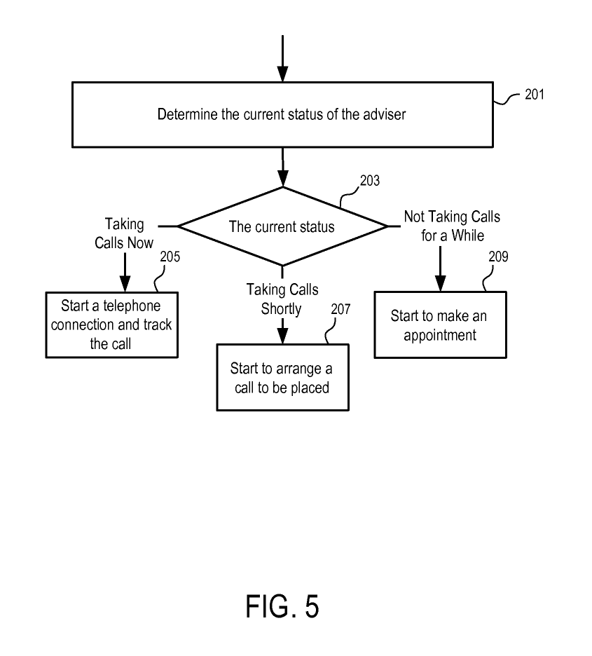

FIGS. 5-12 show examples of flow diagrams of a process to connect a user and an adviser for telephonic conversation according to one embodiment of the present invention.

In one embodiment, when a caller selects (e.g., clicks) on a call button according to one embodiment of the present invention, the selection (e.g., click) leads down several different paths depending on the availability status of the seller.

For example, in FIG. 5, the system determines (201) the current status of the adviser at the time the telephonic connection is started. In one embodiment, the current status of the adviser is determined based at least partially on the information provided by the adviser. For example, the adviser can specify the scheduled hours of the day during which the adviser is expected to take calls; the adviser may select a button (e.g., push through placing a cursor over the button on a display of a graphical user interface and activating a selecting device, such as a key or a button of a cursor positioning device such as a mouse or a touch pad or a joystick, etc.) on a web page, or make a phone call to the system, to indicate whether the adviser is currently busy and not answering new calls and/or to further specify the estimated duration of the busy period. The adviser may select a button on a user interface (e.g., a web page designed for the manage of the listing and/or account of the adviser) to indicate that the adviser is now free and ready to take calls. The adviser may pick up the phone call from the system and indicate to the system the current status of the adviser. The adviser may transmit the current status information to the system using instant messages, email, SMS messages, etc.

If the current status (203) of the adviser is “Taking Calls Now” or something equivalent, the system starts (e.g., immediately) a telephone connection and tracks the call (205).

If the current status (203) of the adviser is “Taking Calls Shortly”, the system starts (207) to arrange the call to be placed within the time period specified by the caller without trying to call the adviser immediately, since the adviser is temporary busy and will be available to take calls within a short period of time.

If the current status (203) of the adviser is “Not Taking Calls for a While” or something equivalent, the system starts (209) to make an appointment for the user to call the adviser, since the adviser is not available to take the call and will not be available for a longer period of time.

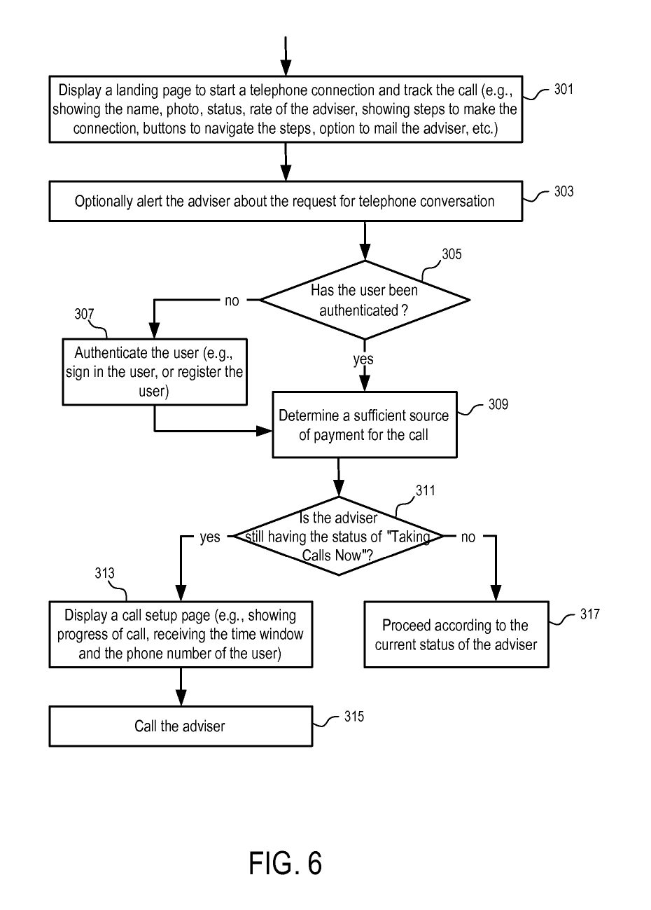

In FIG. 6, when the system starts to at least initiate a telephone connection (e.g., in response to a request from a selected call button), the system displays (301) a landing page to at least initiate a telephone connection and track the call. For example, the web server of the system transmits information defining the landing page to the web browser of the user to show the landing page (e.g., in a pop-up window).

For example, the landing page may show the name, photo, status, rate of the adviser, show/explain the process to make the connection, buttons to navigate the process, option to mail the adviser, etc.

Optionally, the system alerts (303) the adviser about the request for telephone conversation (e.g., through a web-based user interface, or through email, instant messaging, short text message, etc.)

The system determines whether the user has been authenticated (305). If the user has not been authenticated, the system authenticates (307) the user. For example, the system signs in the user if the user is already a member, or registers the user as a new member if the user is not yet a member.

The system then determines (309) a source of payment for the call.

After the system has identified a source of payment for the call based on the price for the call specified by the adviser in the listing, the system may further determine if the adviser is still having the status of “Taking Calls Now”. In certain instances, the process of authenticating the user and securing the source of payment may take an extended period of time such that the availability status of the adviser may have changed.

If the adviser is no longer available for immediate connection, the system proceeds (317) according to the current status of the adviser, based on whether the current status is “Taking Calls Shortly” or “Not Taking Calls for a While”.

If the adviser is still available for immediate connection, the system displays (313) a call setup page. The call setup page may show the progress of call and user interface elements to receive the time window and the phone number of the user (caller).

Once the time window within which the user (caller) is available for the call and the call back phone number of the user is received, the system calls (315) the adviser.

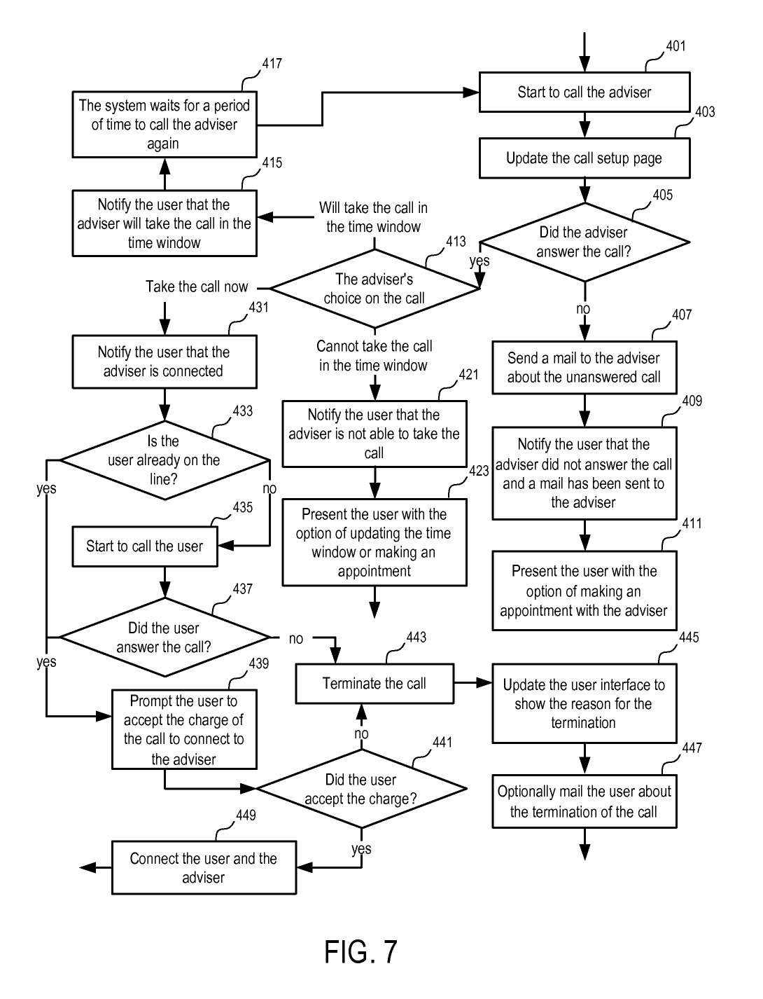

In FIG. 7, after the system starts (401) to call the adviser, the system updates (403) the call setup page. For example, the system may play an animation and/or sound clip and/or a text message to indicate that the system is calling the adviser, in one embodiment.

Then, the system determines whether or not the adviser answered the call (405).

If the adviser failed to answer the call, the system sends (407) a mail to the adviser about the unanswered call. The system notifies (409) the user that the adviser did not answer the call and a mail has been sent to the adviser. The system then presents (411) the user with the option of making an appointment with the adviser.

If the adviser answered the call, the system obtains the adviser's choice (413) on the call.

The adviser may indicate that the adviser will take the call in the time window specified by the caller, in which case, the system notifies (415) the user that the adviser will take the call in the time window. Then, the system waits (417) for a period of time to call the adviser again. Alternatively, the system may try the connection based on an indication from the adviser that the adviser is ready to take the call (e.g., by calling the system, selecting a button or a link on a web page in the account of the adviser, sending an email/instant message/short text message to the system or replying to a message from the system about the call, etc.)

The adviser may indicate that the adviser cannot take the call in the time window specified by the caller, in which case, the system notifies (421) the user (caller) that the adviser is not able to take the call and presents (423) the user with the options of updating the time window and making an appointment.

The adviser may indicate that the adviser wants to take the call now, in which case, the system notifies (431) the user that the adviser is connected and the server is now calling the user (at which point of the process, the caller may or may not one the phone). The system then determines if the user is already on the line (433).

If the user is not already on the line, the system starts (435) to call the user and determines whether the user answered the call (437).

If the user did not answer the call back, the system terminates (443) the call (443) and the adviser is notified.

After the user answers the call back, the user is on one line and the adviser on another line. The system then prompts (439) the user to accept the charge of the call before connection to the adviser and determines whether the user accepts the charge (441).

If the user accepts the charge, the system connects (449) the user to the adviser (e.g., by joining the calls) and starts to monitor aspects of the call (e.g., duration) and charge the user.

If the user rejects the charge or fails to provide a response within a predetermined period of time, the system terminates (443) call. After the termination of the call, the system updates (445) the user interface to show the reason for the termination. Optionally, the system mails (447) the user about the termination of the call.

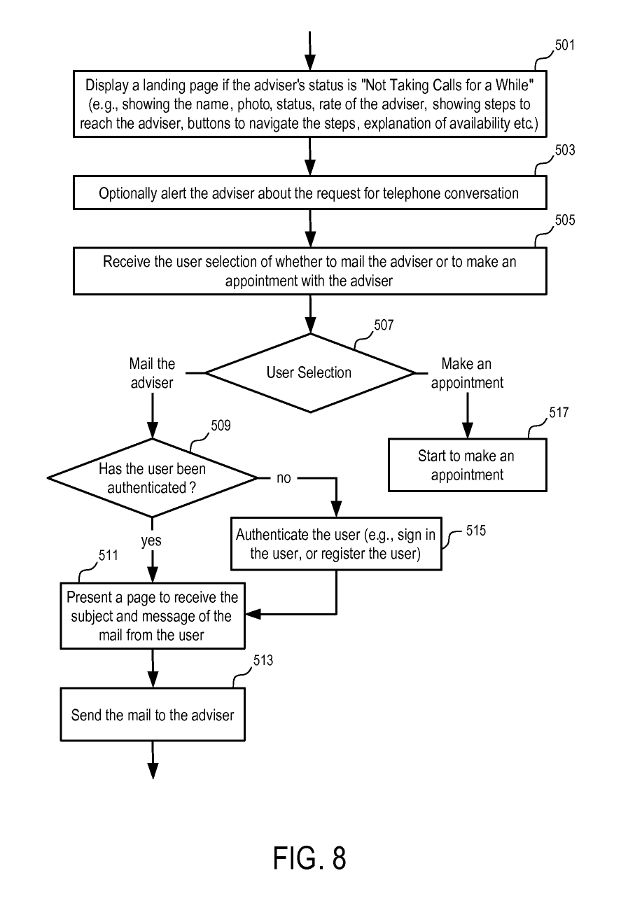

In FIG. 8, the system displays (501) a landing page, if the adviser's status is “Not Taking Calls for a While”. The landing page may show the name, photo, status, rate of the adviser, and show the process to reach the adviser, buttons to navigate the process, explanation of availability, etc.

Optionally, the system alerts (503) the adviser about the request for telephone conversation.

In one embodiment, the system receives (505) from the landing page the user selection whether to mail (e.g., email or use other types of messaging systems) the adviser or to make an appointment with the adviser.

If the user selection (507) is to mail the adviser, the system determines if the user has been authenticated (509). If the user has not been authenticate, the system authenticates (515) the user. For example, if there is no cookie in the web browser of the user indicating that the user is currently in a valid session, the user may be presented with an interface to sign in or to register.

If the authenticated user chooses to mail the adviser, the system presents (511) a page to receive the subject and message of the mail from the user. After receiving the subject and message of the mail, the system sends (513) the mail to the adviser (without showing the mailing address of the adviser to the user and without showing the mailing address of the user to the adviser) in accordance with one embodiment.

In one embodiment, the mail is delivered electronically (e.g., through an email, instant message, SMS message, web mail). Alternatively, the mail may be delivered as voice mail, print out, etc.

If the user selection (507) is to make an appointment, the system starts (517) to make an appointment.

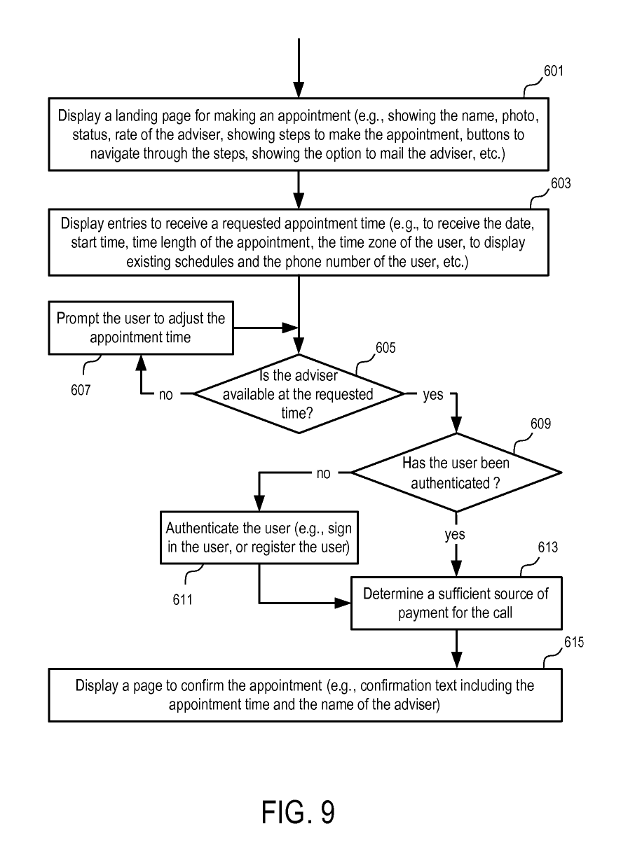

In FIG. 9, the system displays (601) a landing page for making an appointment. The landing page may display one or more of the name, photo, status, rate of the adviser, and show stages of operations to make the appointment, buttons to navigate through the stages of operations, show the option to mail the adviser, etc.

The system displays (603) entries to receive a requested appointment time. The entries can be part of the landing page or a page displayed after a navigation button is selected. In one embodiment, the entries are used to receive one or more of the date, start time, time length of the appointment, the time zone of the user, etc.

In one embodiment, the system further displays existing schedules and the phone number of the user, etc. for the convenience of the user (e.g., if the user is already authenticated at this point of the process).

After the requested time of the appointment is received from the user, the system determines if the adviser is available at the requested time (605). If the adviser is not available at the requested time, the system prompts (607) the user to adjust the appointment time; otherwise, the system proceeds to the task of filtering the callers.

If the system determines that the user has not been authenticated (609), the system authenticates (611) the user through signing in the user or registering the user. The system then determines (613) if a sufficient source of payment for the call is available from the user.

If there is a sufficient source of payment for the call, the system accepts the appointment and displays (615) a page to confirm the appointment. The confirmation page may show confirmation text including the appointment time and the name of the adviser.

In one embodiment, after the appointment is made, the system automatically starts to make connections to the caller and the callee separately at the requested time of the appointment. Alternatively, the system may reserve a time slot on the schedule of the callee on behalf of the caller and request the caller to make a request for a connection at the scheduled time. Alternatively, the system may request the adviser (callee) to make the request for the connection. For example, the system may determine a less reliable one of the two to make a request for the connection, or contacting the less reliable one first, during the appointment time is reached before starting to contact the other party.

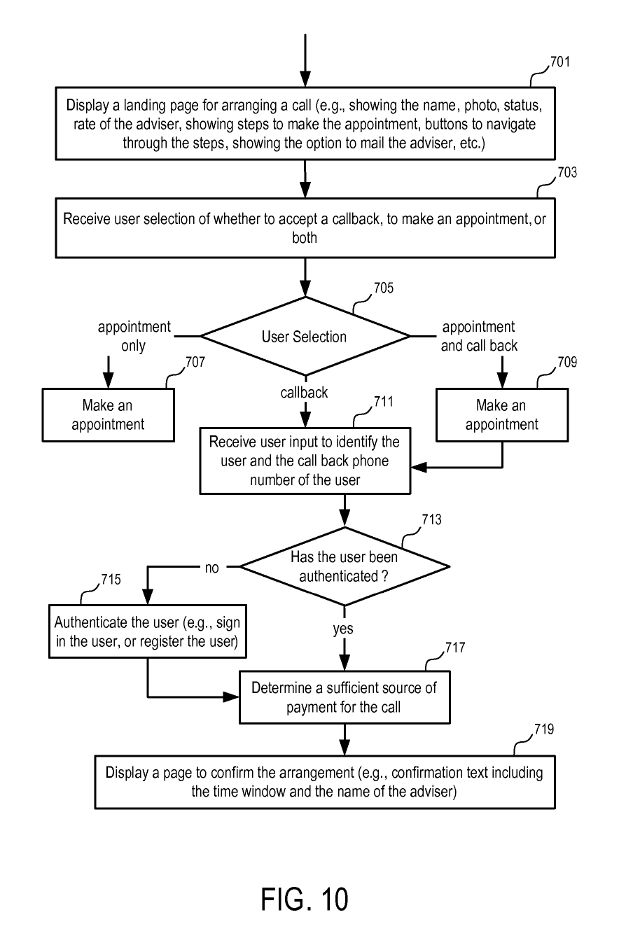

In FIG. 10, the system displays (601) a landing page for arranging a call. The landing page may display one or more of the name, photo, status, rate of the adviser, show stages of operations to make the appointment, buttons to navigate through the stages, show the option to mail the adviser.

The system receives (703) a user selection of whether to accept a callback, to make an appointment, or both.

If the user selection includes making an appointment, operation 707 or operation 709 is performed to set up an appointment (e.g., according to the process illustrated in FIG. 9).

If the user selection includes accepting a callback, the system receives (711) user input to identify the user and the call back phone number of the user and determines whether the user has been authenticated (713). If the user has not yet been authenticated, the system authenticates (715) the user (e.g., through signing in the user or registering the user).

After the user is authenticated, the system determines (717) if a sufficient source of payment for the call is available (e.g., to filter out non-serious callers). The system then displays a page to confirm the arrangement (e.g., confirmation text including the time window and the name of the adviser).

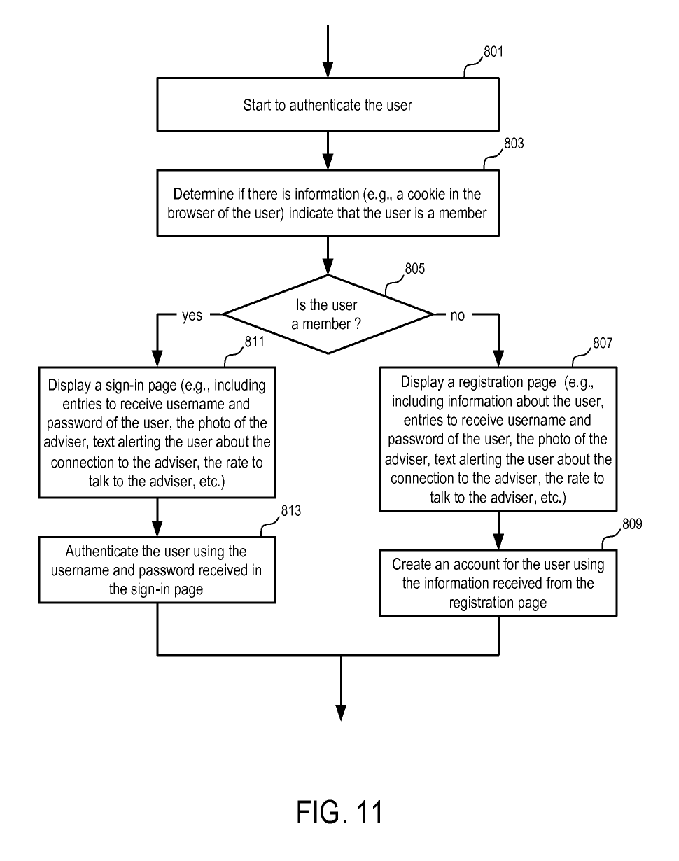

FIG. 11 shows an example to authenticate the user. In FIG. 11, after the system starts (801) to authenticate the user, the system determines (803) if there is information to indicate that the user is a member. The information may be in a cookie in the browser of the user, or a parameter encoded in an URL (universal resource locator) of a link, or a parameter in an applet running in the web browser.

If the user is a member (805), the system displays (811) a sign-in page which may include entries to receive a username and a password from the user. In one embodiment, the sign-in page may optionally further include the photo of the adviser, text alerting the user about the connection to the adviser, the rate to talk to the adviser, etc. Thus, the sign-in appears to be in the environment of the adviser. The system then authenticates (813) the user using the username and password received in the sign-in page.

If the user is not a member (805), the system displays (807) a registration page. The registration page may include information already collected about the user (e.g., during the interaction before the registration) for confirmation purpose. The registration page includes entries to receive username and password of the user. In one embodiment, the registration page may optionally further include the photo of the adviser, text alerting the user about the connection to the adviser, the rate to talk to the adviser, etc. Thus, the registration appears to be in the environment of the adviser. The system then creates (809) an account for the user using the information received from the registration page.

In one embodiment, after the user is authenticated, information is created to indicate that the user is authenticated for a valid session (e.g., using a cookie, a parameter in URL or in an applet) until the session expires or the user signs off.

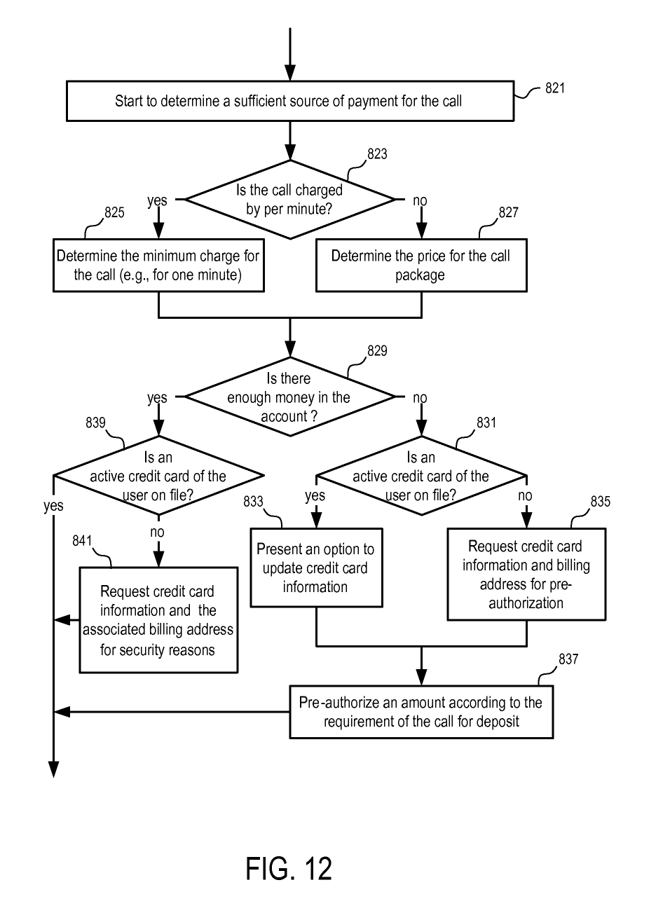

FIG. 12 shows an example to determine if a sufficient source of payment of the call is available.

After the system starts (821) to determine if a sufficient source of payment for the call is available, the system determines (823) whether the call is charged by per interval (e.g., per minute). If the call is charged by per interval, the system determines (825) the minimum charge for the call (e.g., for one minute). If the call is not charged by per interval, the system determines (827) the price for a call package (e.g., $100 for 1 hour, as specified by the adviser).

The system then determines whether there is enough money in the account of the user (829) and/or whether there is an active credit card of the user is on file (839 and 831).

If the account of the user has enough money for the call and/or an active credit card of the user is not on file, the system optionally requests (841) for the credit card information and the associated billing address for security reason.

If the account of the user does not have enough money for the call, the system will pre-authorize (837) an amount according the requirement of the call for deposit purpose. If an active credit card of the user is on file, the system optionally presents (833) an option to update the credit card information. If no active credit card of the user is on file, the system requests (835) credit card information and billing address for pre-authorization.

In one embodiment, when information identifying the user is available (e.g., through a “cookie” implemented in the web browser or parameters encoded in the URL, or parameters stored in the variables of an applet running in the web browser, etc.), the system uses the information about the user to help the user. For example, from the member information database, the system may retrieve the phone numbers of the user. If there are multiple phone numbers for the user, a combo box is displayed for the user to select one from the known phone numbers of the user (or to type in a different one). If there is only one known phone number of the user, the system may display the known phone number of the user in an entry box as the default value.

If a user as identified by the information (e.g., cookie) is different from the current user, the current user can choose to edit the information and/or sign in as a different user.

In one embodiment, a user can enter the input information to set up a call, such as the call window and/or the callback phone number before the user is authenticated. When the user is subsequently authenticated (e.g., through signing in as an existing member or registering as a new member), the information provided by the user before the authentication process is used to update the account information (if changed).

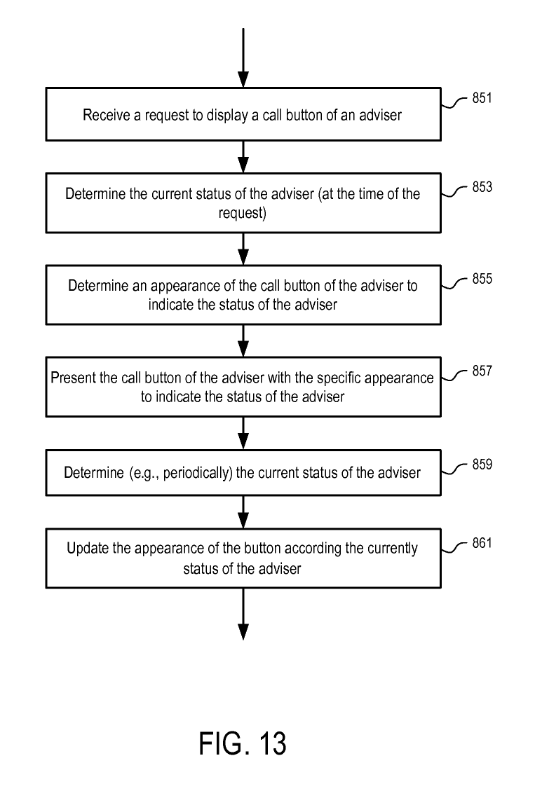

FIG. 13 illustrates a method to display a call button according to one embodiment of the present invention.

In one embodiment, the appearance of a call button is displayed according to the current availability status of the adviser to take the call.

For example, in FIG. 13, when the system receives (851) a request to display a call button of an adviser, the system determines (853) the current status of the adviser (at the time of the request). After the system determines (855) an appearance of the call button of the adviser to indicate the status of the adviser, the system presents (857) the call button of the adviser with the appearance to indicate the status of the adviser.

In one embodiment, the system further determines (859) (e.g., periodically) the current status of the adviser to update (861) the appearance of the button according the currently status of the adviser.

For example, the call button to be inserted in the blog of the callee can include an image at a URL on a server computer. When being requested the URL causes the server computer to determine a response based on the parameters encoded in the URL. For example, the URL can be pointing to a CGI (Common Gateway Interface) program which provides or generates the image according to the current status of the adviser. The URL may include a parameter to identify the adviser and/or the advertisement.

For example, when the current status of the adviser is “Taking Calls Now”, the call button may show a telephone with text “Call Now”; when the current status of the adviser is “Taking Calls Shortly”, the call button may show an off-hook telephone with text “Arrange a Call”; when the current status of the adviser is “Not Taking Calls for a While”, the call button may show a telephone and a calendar with text “Appointment”.

In one embodiment, different types of availability status of a callee (adviser) includes: on call, off call, busy, get in line, schedule an appointment, join conference, etc. It is understood that different systems may implement more or less types of availability status of a callee. Further, the call button may include other current status information about the callee, such as price, how many people are in line to call the callee, the schedule of the callee, and/or others.

In one embodiment, the call button is implemented using an applet running in the browser of the user. The applet displays the call button according to the current status of the adviser and checks the status of the adviser periodically to update the appearance of the button. In one embodiment, when an estimated time until which the adviser can take the call is available (e.g., received in the system from the adviser when the system attempts to contact the adviser, or provided by the adviser when the adviser is talking to a different user, etc.), the call button also shows an indication of such an estimated time to help the user in selecting a time window.

Alternatively, the call button may be implemented in custom applications (e.g., as plug-in to web browsers, email clients, etc., or as stand-along applications). The call button may communicate with the server using a special purpose protocol.

In one embodiment, a web/email (document) authoring tool is designed to automatically detect the phone number of the callee in a web page/email/document. The authoring tool can be set up to replace the phone number of the callee with the corresponding call button assigned to the callee and/or the phone number (e.g., ether phone number) that is assigned to the callee. For example, the authoring tool can detect the occurrence of the phone number of the callee in the document and prompt the user of the authoring tool to replace the phone number of the callee with the call button and/or the phone number assigned by the system. If the user accepts the suggestion, the authoring tool automatically replace the phone number of the callee with the call button and/or the phone number assigned by the system.

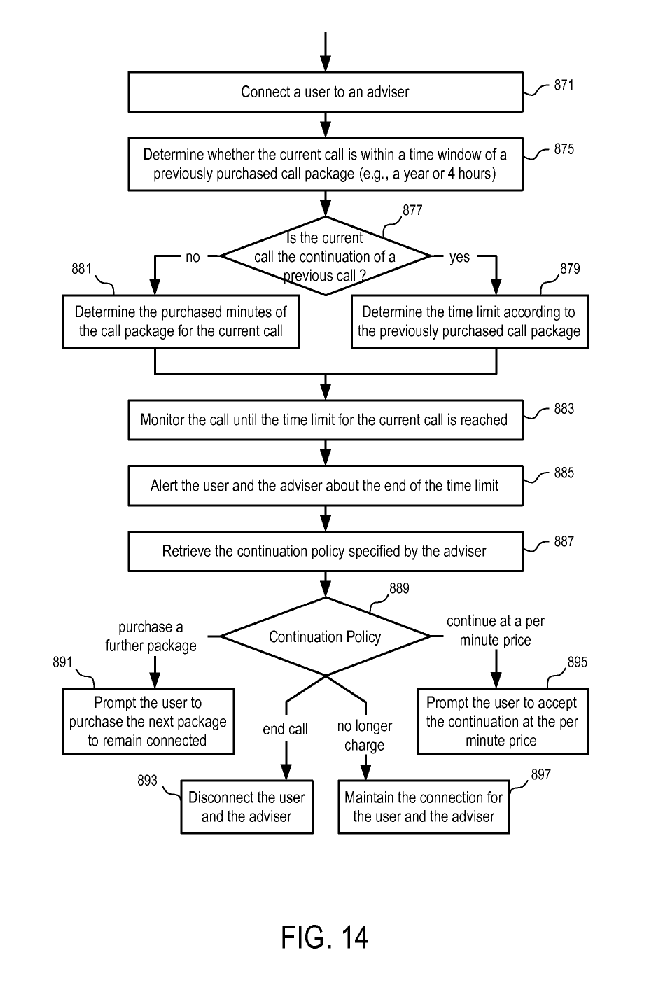

FIG. 14 illustrates a method to monitor and control a connection according to one embodiment of the present invention.

In FIG. 14, after the system connects (871) a user to an adviser, the system determines (875) whether the current call is within a time window of a previously purchased call package (e.g., a year or 4 hours).

In one embodiment, a call is considered a continuation of the previously purchased call package if the current call is within the time window. Thus, if the call of a previously purchased call package is interrupted, the user can continue the call within the time window without having to purchase another package.

Based on whether or not the current call is the continuation of a previous call (877), the system determines (879) the time limit according to the previously purchased call package, or determines (881) the purchased minutes of the call package for the current call. The system then monitors (883) the call until the time limit for the current call is reached. When the time limit for the call is reached, the system alerts (885) the user and the adviser about the end of the time limit.

In one embodiment, the continuation policy specified by the adviser is retrieved (887) to process the call at the end of the time limit.

If the continuation policy (889) is “purchase a further package”, the system prompts (891) the user to purchase the next package to remain connected. For example, the user may be offered to continue the call at the price of $50 for another 30 minutes.

If the continuation policy (889) is “continue at a per minute price”, the system prompts (895) the user to accept the continuation at the per minute price.

If the continuation policy (889) is “no longer charge”, the system maintain (897) the connection for the user and the adviser until at least one of the user and the adviser hangs up.

If the continuation policy (889) is “end call”, the system disconnects (893) the user and the adviser after altering the user and the adviser.

In one embodiment, the system stores a replication of the policy of the package the user purchased with the records of the purchased call (e.g., the policy at the time the call button is selected for the call package, or at the time the user is first connected to the adviser for the call package, or at the time the user explicitly confirms the purchase of the call package, etc.). Thus, the adviser is free to change the listing for the future callers even before the users finish the purchased call packages without retroactively affecting the purchased calls.

Some of the above examples are in the context of telephonic conversations. From this description, it will be understood that the techniques for connecting people for real time communications can also be applied to other types of communications, such as video and other multimedia channels, chat, instant messaging, document sharing, or screen-sharing, common “whiteboarding,” interactive TV or internet TV, etc. Each of different multimedia channels can have different prices or be inclusive in one price (e.g., the use of part or all of the different channels can be included in the same price).

The real time communication may be on a one-to-one basis (e.g., one caller connected to one callee). The real time communication can also be in the form of one-to-many. For example, the seller may be hosting a conference in which multiple callers may attend. For example, 100 people can be in the same call or the same video session provided by the same seller.

Further, in one embodiment, the real time communication may include access to recorded sessions (e.g., recorded audio content and/or recorded video content).

Thus, the system on the whole may be used as a filter for sellers (callees), only letting in calls from people who are serious they're serious because they have entered their credit card and are willing to pay. Celebrities can use the system. For example, people want to talk to the Oakland A's from the 70's, who are sitting on their porches these days. For example, Hollywood executives can use the system to hear pitches from scriptwriters who are willing to pay $1000 for the chance to pitch their script.

In one embodiment, these call buttons and the Ether phone numbers go to where the action is happening. In at least one embodiment of the present invention, it is recognized that not all service commerce will happen through marketplaces, such as keen.com or a search engine. People who want to talk to the Oakland A's players are more likely the visitor of the web site www.oaklandathletics.com—and that's where the call buttons can be very effective. And the Ether phone numbers can be in magazines, underneath photographs, in newspapers, on business cards, etc.

In one embodiment, the current status of the callee (e.g., availability, schedule, etc.) and guidance and instructions for the phone connection are provided through the appearance of the call button and the content of the call graphic. Alternatively or in combination, the status information, guidance and instructions can also be presented based using an interactive voice response (IVR) system.

For example, a talk radio station may have a guest on every day at a noon talk show. After the one-hour show, the radio announcer may say, “The time is up on our show. We've enjoyed talking with Dr. Webber and answering your calls. If you'd like to talk further with Dr. Webber, go to our website at WKBR.com and set up a conversation with him. Or, just dial the number 1-800-TALK-KBR and get in line. It's just $29 per 10-minute conversation.”

In this example scenario, the phone number 1-800-TALK-KBR is assigned to Dr. Webber, which can be used to achieve many of the same goals as the call button assigned to Dr. Webber. While the button can visually communicate to the user the current (e.g., real-time) availability of the callee, the price, how many people are in line already, the schedule of the callee, etc., telephony prompts on a interactive voice response (IVR) system can also be used to provide such information after the caller dials the phone number that is assigned to the callee.

For example, in one embodiment, after a caller dials the phone number 1-800-TALK-KBR, the call is connected to a server, which determines that the call is for Dr. Webber since the phone number 1-800-TALK-KBR is assigned to (associated with) Dr. Webber. The server can then determine the current status of Dr. Webber, including the availability status, the price for the package, etc., and provide the information to the caller through the IVR system. In one embodiment, the server prompts options according to the current availability status of Dr. Webber. For example, the server may offer an immediate connection when Dr. Webber is available for immediate talk, or an opportunity to input a callback time window and/or callback phone number when Dr. Webber is expected to be available in a short period of time, or an opportunity to schedule an appointment with Dr. Webber when Dr. Webber is not expected to be available in a short period of time, etc. The server may use the IVR system to inform the caller the current status of the connection process and to provide instructions to the caller to take actions, such as providing a callback time window, providing an appointment time, providing an indication to accept the price of the call package, etc.

In one embodiment, the status information, instruction and guidance are provided using a combination of graphical presentations (e.g., over a graphical user interface terminal) and voice prompts (e.g., through an IVR system).

In one embodiment, the callee (seller) charges the caller(s) for the real time communication. The system provides the service to arrange and connect the call. The system can collect the payment from the caller(s), deduct a portion of the payment as fees to provide the service, and deliver the remaining payment to the callee (seller).

Alternatively, the callers may be not required to pay for the call; and the callee (e.g., advertisers) may pay the system for the service. In this case, the system may not provide the filtering functionality based on the willingness of the callers to pay. However, the callees (e.g., the advertisers) can still enjoy other benefits from the service provided by the system, such as call scheduling (no night calls), call queuing, toll-free number, local phone number, click-to-call, etc.

In one embodiment, the call buttons and the phone numbers assigned to the callees can also be published in advertisements in marketplaces, online or offline, on behalf of the callees; the callees bid for changes of the publicity and pay the bid amount on a per call basis for calls generated by the advertisements. When the callees generate the phone lead from their own media channel, the callees are only charged for a flat fee for the service of making the connection. Thus, in one embodiment, the system tracks the media channels that lead the caller to make the call.

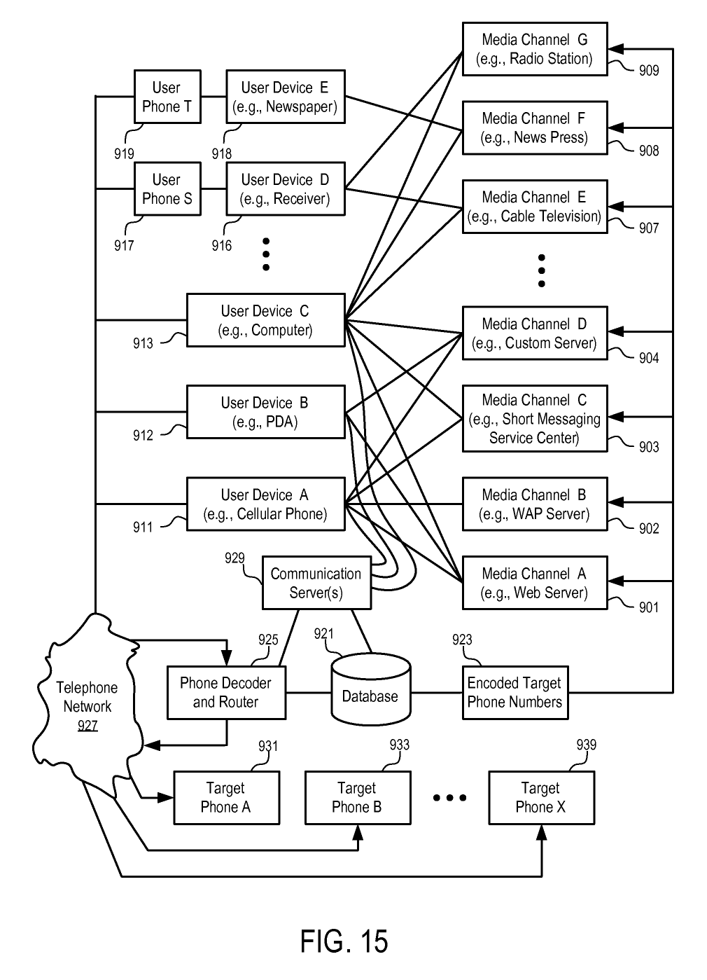

FIG. 15 shows a diagram of a system to assist and track connections according to one embodiment of the present invention.

In FIG. 15, a database (921) may contain the phone numbers of target phone A (931), target phone B (933), . . . , target phone X (939), etc., of callees. Typically, the target phones belong to the institutions, businesses, individuals, etc, which seek for the services of embodiments of the present invention.

The call button and/or phone numbers assigned to the callees are distributed in various media channels, such as media channel A (901) (e.g., web server), media channel B (902) (e.g., WAP server), media channel C (903) (e.g., short messaging service center), media channel D (904) (e.g., custom server), media channel E (907) (e.g., cable television), media channel E (908) (e.g., news press), media channel G (909) (e.g., radio station), etc.

In one embodiment of the present invention, the call buttons and/or the assigned phone numbers, which can be considered as the encoded phone numbers of the callees, are presented in the environment specific to the callees, not in the marketplaces that are specially designed to advertise the callees. Thus, the callees generate the phone leads on their own media distributions, such as their web site or blog site.

Alternatively, or in combination, the call buttons and/or the assigned phone numbers can also be presented in marketplaces, such as in listings/directories of services, advertisements in search results, etc.

In one embodiment of the present invention, the phone numbers of the target phones are not directly publicized over the media channels. Instead, encoded target phone numbers (923) are used. Using the encoded target phone numbers (923), a user cannot reach target phones directly. Using the encoded target phone numbers (923), a user reaches a server of the system first, which allows the system to provide various services before actually connecting the user to the callee, such as filtering, payment processing, etc.

The encoded target phone numbers (923) allow the association of additional information with the target phone numbers, such as the media channels used, special promotions, etc.

The encoded target phone numbers and/or the call buttons are delivered with content information (e.g., web page, WAP page, short message, television programs, news articles, advertisement, blog, etc.) to user devices, such as user device A (911) (e.g., cellular phone), user device B (912) (e.g., personal digital assistant (PDA)), user device C (913) (e.g., computer), user device D (916) (e.g., receiver), user device E (918) (e.g., newspaper).

In one embodiment, a user device can include a USB phone, a Bluetooth wireless phone, or one or more speakers or headphones with one or microphones for the implementation of a software based phone.

In one embodiment, the user devices/phones support one or more real time communication capabilities, such as VoIP using Session Initiation Protocol (SIP) which may support video and instant-messaging applications, IP phone, regular phone over VoIP service, Bluetooth wireless phone, USB phone, software based phone, and other forms of IP telephony.

In one embodiment, the user device can include a television set to receive the advertisement. Further, the television set may have the capability to accept user input so that the television content may be changed according to the user input (e.g., interactive television, web television, internet television, etc.), or be coupled with a set top box which has such capability. The user input may be provided to the content provider through the same communication channel in which the television content/programs are delivered (e.g., a cable system of a cable television system), or a separate channel (e.g., a phone line, an Internet connection, etc.). The user input may include a request to make a connection to an advertiser featured in an advertisement presented in a television program, such as a request for a telephonic connection to the advertiser.

In one embodiment, the user devices are mobile devices, such as PDA, cellular phone, etc. The user devices obtain content information, including advertisements, through wireless communication connections, such as cellular communication links, wireless access points for wireless local area network, etc.

In one embodiment, a user device (e.g., a cellular phone, a computer, a PDA) can receive content information from multiple types of media channels (e.g., a web server, a WAP server, an SMSC, etc.).

In one embodiment, a user device is capable of dialing a phone call (e.g., automatically according to the encoded phone number embedded in the content information when a user selects the number). Alternatively, a user may manually dial a phone call using a separate phone, such as user phone S (917) or user phone T (919).

In one embodiment, a user device (e.g., 911, 912, 193) is capable of rendering the call button and sending a message to the communication server(s) (929) when the call button is activated. The call button includes an identifier of the callee so that when the call button is activated the user devices communicates the identifier of the callee to the server(s) (929).

In one embodiment, the user device (e.g., 911) is further capable of automatically identifying a phone number of the caller, or a VoIP identifier of the caller, as a callback number. Alternatively, the user device (e.g., 911, 912, 913) is capable of communicating with the server(s) (929) to present user interfaces to receive the callback number and other parameters, such as the callback time window.

In one embodiment of the present invention, dialing at least a portion of an encoded target phone number connects the phone call to a phone decoder and router (925) first. According to the encoded target phone number dialed, the phone decoder and router (925) determines the corresponding target phone number using the database (921) and connects the phone call to the corresponding target phone (e.g., one of target phones 931-939) through the telephone network (927).

Note the telephone network (927) may be circuit switched, package switched, or partially circuit switched and partially package switched. For example, the telephone network may partially use the Internet to carry the phone call (e.g., through VoIP). For example, the connection between the user phone/device and the phone decoder and router (925) may be carried using VoIP; and the connection between the phone decoder and router (925) may be carried using a land-line based, circuit switched telephone network.

In one embodiment of the present invention, the information associated with the encoded target phone number, such as the media channel used to provide the encoded target phone number to the users, is also decoded/retrieved using the database (921). Thus, the information associated with the encoded target phone number can be tracked/stored.

In one embodiment, the phone decoder and router (925) also determines the phone number of the user through Automatic Number Identification (ANI). ANI is a phone system feature that provides the billing number of the person making the phone call.

The information about the caller, target phone number, the media channel used for delivering the contact information to the user can be used to bill the caller and/or the target phone number, and provide credit/compensation for the corresponding media channel.

For example, the connection to target phone numbers can be paid for on a pay per call basis. Monitoring and tracking the calls can be used for billing the callee and/or the caller.

In one embodiment of the present invention, the additional information associated with the encoded target phone number is used to tracking phone calls for conditional promotions, electronic coupons, etc. Alternatively, the additional information for conditional promotions, electronic coupons, etc. are retrieved from the database of the listings at the time the corresponding call button is activated or presented, or at the time the encoded phone number is called.

The information about the media channels that are responsible for leading the users to the phone calls to the target phones can also be useful for the advisers. The advisers may wish to know which media channel is more effective in reaching users.

In one embodiment of the present invention, an encoded target phone number has the same number of digits as a standard phone number (e.g., a typical telephone number assigned by a telephone company). Thus, dialing the encoded target phone number is as easy as dialing the target phone number; and dialing the target phone number reaches the phone decoder and router (925). In such an arrangement, a large number of encoded phone numbers are generally required to differentiate the different target phones and different media channels.

In one embodiment of the present invention, an encoded target phone number has more digits than a standard phone number (e.g., having an extension to the standard phone number). A first portion of the encoded target phone number has the same number of digits as a standard phone number to reach the phone decoder and router (925) through the telephone network (927); and a second portion of the encoded target phone number (e.g., the extension) is to be decoded by the phone decoder and router (925). For example, the Dual Tone Multi-Frequency (DTMF) decoder can be installed in the phone decoder and router (925) to detect the second portion of the encoded target phone number dialed at the user phone. The detected phone number can then be used to recover the target phone number.

In one embodiment of the present invention, a single telephone number is used to reach the phone decoder and router (925) for different target phone numbers; and the portion of the encoded target phone number that is used to reach the phone decoder and router (925) is not used in determining the information associated with the encoded target phone number.

Alternatively, multiple telephone numbers can be used to reach the phone decoder and router (925); and the entire encoded target phone number can be used to determine the information associated with the encoded target phone number.

In one embodiment of the present invention, the encoded target phone numbers can have different numbers of digits. The callees may be arranged to bid for shorter encoded target phone numbers.

In one embodiment, a look-up table approach is used to encode the information. For example, the database (921) keeps track of the information about the media channel and the target phone number (and other information, if any) for the encoded target phone number so that the encoded target phone number can be used as a key to retrieve the corresponding information. Thus, it is not necessary to have a predetermined structure to encode the information about the media channels and the target phone number.

Alternatively, algorithms can be used to generate and encode target phone number and associated information. For example, a predetermined algorithm may be used to encode different information in the target phone number. For example, the target phone number may include a number of field separated by “*” or “#”. Each of the field can be decoded separately (e.g., from a separate look up table or a mapping algorithm) to determine the target phone number, identity of the media channel, etc.

For example, a set of parameters can be mapped from a string of characters to a string of numerical digits as a part of the encoded target phone number; and the string of numbers can be mapped back into the string of characters at the phone decoder and router (925). When such a mapping scheme is used, a look up table is not necessary. For example, an encoded target phone number may include a first portion that is the phone number of the phone decoder and router (925), a second portion that is the target phone number appended with other parameters. To prevent revealing the target phone number and the parameters, an encryption/scrambling scheme can be used to encode the second portion, which is decoded at the phone decoder and router (925).

In one embodiment, the phone decoder and router (925) determines the target phone number from the encoded target phone number dialed by the user and then dials the target phone number for the user and joins the phone calls so that the user can talk to the target phone.

In one embodiment, the communication server(s) (929) determines the target phone number from the message sent from the user devices when the call button is pressed.

In one embodiment of the present invention, users dial the encoded target phone numbers manually. A user can dial the encoded target phone number regardless the user device used and the media channel used.

Alternatively, in one embodiment, user devices can automatically dial the encoded target phone numbers. For example, a cellular phone, a computer or a PDA can dial a phone number using a Dual Tone Multi-Frequency (DTMF) generator. In one embodiment of the present invention, the encoded target phone numbers are presented in the content information in a format such that when the user selects the phone number the user device (e.g., a cellular phone or a computer) dials the encoded target phone number for the user. The user selection may be in the form of an keyboard/keypad input, a touch pad input, a track ball input, a mouse input, a voice command, etc.

In one embodiment, the user device initiates the phone call through a VoIP system when the user selects the encoded target phone number. Alternatively, the system initiates the VoIP connection to the user device after receiving the message from the user device requesting the phone connection.

In one embodiment of the present invention, the user device dials the phone number for the user without the user manually press the sequence of the encoded target phone numbers. This greatly simplifies the process of make the phone call. Since a user device can dial a long sequence of number easily, a large number of digits can be used to encode the information without presenting any difficulties for the users.

In one embodiment of the present invention, the encoded target phone numbers are formatted so that the user device dials a first portion of the encoded target phone numbers to access the phone decoder and router (925), pauses for a short period of time for the phone decoder and router (925) to prepare for receiving the second portion of the encoded target phone numbers, and then dials the second portion of the encoded target phone numbers. Thus, the user device provides a user-friendly way of dialing the encoded target phone numbers; and, making the phone call can be as easy as making a “click” to access a web page.

In FIG. 15, the user device initiates the phone call. Alternatively, a phone router may be used to initiate phone calls both to the user device (or a separate user phone) and the target phone and then join the phone calls to connect the user to the target phone. For example, when the user selects the call button, the encoded target phone number is transmitted to the communication server(s) (929), which can instruct the phone decoder and router (925) to initiate the phone calls.

The user phone number can be automatically determined through ANI, or through a user preference setting, or through an entry submitted with the selection of the encoded target phone number (e.g., the call button).

In one embodiment, the selection of the encoded target phone number is transmitted to the corresponding media channel, which forwards the request for making the phone call to a server (e.g., a web server) connected to the phone router. Alternatively, the content information can be formatted so that the selection is sent directly to the server that is connected to the phone router.

When the router starts the phone calls, the encoded target phone number can also include alphabetic characters (and/or other characters). The server and/or the phone router can decode the encoded target phone number to recover/retrieve the target phone number and other associated information, such as the identity of the media channel that is creditable for providing the encoded target phone number to user.

In one embodiment, the user devices/phones support one or more real time communication capabilities, such as VoIP using Session Initiation Protocol (SIP) which may support video and instant-messaging applications, IP phone, regular phone over VoIP service, Bluetooth wireless phone, USB phone, software based phone, and other forms of IP telephony.

Changing a Fee Status of a Call Period

In one embodiment of the invention, a callee may elect to allow anonymous callers to initiate calls for free for an initial period of real time communication without charge to the caller. The free call may be converted to a fee-based call. A caller may be connected to the callee anonymously regardless of the fee status of the call, so that information related to the identity of the caller (e.g., phone number, IP address of the caller) is not revealed to the callee.

Further, the caller may make the free call without having to identify a source of payment to the system. The source of payment (e.g., a credit card number or a member identification) may be identified after an initial period of communication that is free of charge to the caller. The conversion from the free call to a fee-based call may be performed without the system having to reestablish the communications to the caller and/or the callee.

Alternatively, the system may request the caller to identify a source of payment before completing the connection between the caller and the callee, to speed up the subsequent conversion process and/or to screen callees base on whether callees are willing to supply the payment information.

In one embodiment, the system may charge the callee for the initial period of real time communication which is free to the caller. The free period is not charged by the callee for the service over the communication link and not charged by the system for providing the connection, although other parties may charge the caller. For example, air time may be charged by a cellular phone carrier if the caller uses a cellular phone for the call. Alternatively, the system may make the initial period of real time communication free of charge to both the caller and callee.

In one embodiment, the caller may initiate the free call using a call button that is assigned to the callee. Alternatively, the caller may initiate the free call using the phone number (e.g., Ether phone number) that is assigned to the callee.

For example, during the setup process when the callee is configuring the options for the call button, the callee may select an option to allow callers to establish an initial connection with the callee at no charge to the caller. In addition, the callee may select a key on a touch-tone dial pad, which when pressed causes the system to convert the free call to a fee-based call (or continue the free call with a fee-based call). This allows the caller to speak with the callee prior to deciding whether or not the caller would like to pay for the call. Similarly, this provides the callee with an opportunity to introduce himself or herself, and discuss his or her qualifications with the caller, prior to charging the caller for the call. Further, the callee may provide a period of service free of charge to the caller over the real time communication connection to allow the caller to obtain a “taste” of the service. The callee may also use the free period to screen the caller and decide whether or not to provide service to the caller and, if so, at what rate and/or at what discount level. For example, the caller and callee may negotiate a price for the call during the initial free period.

In one embodiment, the caller is informed of the opportunity of the free call and the conversion to a fee-based call, prior to the initiation of the call. When the caller initiates the call through a web-based interface (e.g., a call button which leads to a call graph), the caller may be informed of the fee status during the call period via the web-based interface. During the call, the caller may be guided through the connection process and/or the fee status conversion process.

When the caller makes the call without an associated web interface, the caller may be informed of the fee status, and guided through the connection process and/or the fee status conversion process via voice prompt. For example, an interactive voice response (IVR) system can be used to provide information and guide the caller.

In one embodiment, the system makes separate connections to the caller and callee. The separate connections are joined by the system to connect the caller and the callee. The system may selectively provide voice prompt to the caller but not to the callee, or to the callee but to not the caller, or to both the caller and the callee. For example, when providing voice prompt to the caller but not to the callee, the system may insert the voice prompt into the caller side of the communication connection but not the callee side of the communication connection.

When providing the voice prompt to the caller but not to the callee, the system may also forward the signals from the callee to the caller. Alternatively, the system may temporarily mute, stop, reduce or transform the signals from the callee, so that the signals from the callee are filtered or combined with the voice prompt. Similarly, when providing the voice prompt to the callee but not to the caller, the system may forward the signals from the caller to the callee, or temporarily mute, stop, reduce or transform the signals from the caller, so that the signals from the caller are filtered or combined with the voice prompt.

In one embodiment, the system may provide an indication to inform the caller that the voice prompt is provided to the caller but not to the callee. For example, the system may explain this at the beginning of the voice prompt, and/or provide a different tone or voice for the voice prompt that is provided to the caller but not to the callee, and/or provide a short sound alert (e.g., a beep or ring with a distinct tone) to indicate that the voice prompt is private to the caller. Similar arrangements can be made when the system provides voice prompt to the callee but not to the caller.

In one embodiment, the system monitors the signals from the caller and the callee separately for the conversion process. The callee may initiate or request the conversion. For example, when the callee presses the “#” key during the free call, the conversion process is initiated; and the conversion process is not initiated if the “#” key is pressed by the caller but not by the callee, during the free call period. Once the conversion process is initiated, the system may prompt the caller to accept the conversion by pressing the “#” key. After the conversion process is initiated, the system switches the fee status of the call if the “#” key is pressed by the caller; and the system would not switch the fee status if the “#” key is pressed by the callee but not by the caller.

Alternatively, the callee may be responsible for asking the caller to provide an indication (e.g., pressing the “#” key) to start a fee based call period. It may not be necessary to detect the request to initiate the conversion process. The system monitors the signals from the caller to detect the indication to start the fee based call period, or to accept the conversion. Once the indication to accept the conversion is received from the caller, the system may further ask the caller to confirm the selection, to avoid conversion that is based on accidental pressing of the key.

Alternatively, the system may initiate the conversion based on a pre-determine criterion. For example, the callee or the system may specify a time limit for the free call (e.g., 3 minutes). When the time limit is reached, the system prompts the caller to continue the call with a fee. The fee-based call may be a call package for a specified duration of real time communication at a specified price. The duration and the price may be specified by the callee before the call or during the call, or be selected by the caller from a set of offers from the callee.

Alternatively, the system may provide several options to continue the call with a fee. For example, the continuation policy similar to, or same as, the continuation policy for a purchased call package may be specified by the callee and used to continue the free call into a fee-based call. For example, to continue the communication connection with the callee, the caller may purchase a call package with bulk minutes, or be charged a per minute fee, or purchase a call package with minutes specified by the caller.

Alternatively, the callee may specify the fee when requesting the conversion. For example, the callee may press “#50*30#” to request the conversion and offer the call package at a price of $50 for 30 minutes. The system can then provide voice prompt and/or web-based guide to the caller. For example, after determining the fee information, the system may read it to the caller without reading it to the callee. Alternatively, the callee may specify the fee and/or initiate the conversion through a web-based interface while talking to the caller on a separate real time communication connection.

The indication to accept the conversion and/or the indication to request the conversion may be generated from pressing a sequence of one or more keys of a touch tone phone. The signals generated from pressing the sequence of keys may be in a Dual Tone Multi-Frequency (DTMF) format. The caller or callee may generate such signals through pressing the key sequence on a dial pad or causing a software program to generate such signals.

When the caller has access to both the web interface and the phone connection during the free call, the caller may accept the conversion through providing input over the phone connection or a web-based call graph.

During the conversion period, the system may temporarily break the two connections while keeping separate connections to the caller and the callee, or allow the caller and callee to continue talking to each other during the conversion period.

During the conversion period, the system may request the caller to provide information to process payment and/or authenticate the caller. The caller may provide the payment information through a web-based interface (e.g., call graph), or through the real time communication connection. After the caller is prompted to provide payment information (e.g. credit card number or member ID) over the real time communication connection, the system does not forward the signals from the caller to the callee for a period of time to protect the payment information. For example, the system may provide the voice prompt “Your line is now muted to the callee. Please key in your member identification number and then press the * key”. Thus, the caller provides the payment information to the system but not to the callee.

In one embodiment, during a fee-based call, the callee (or the caller) may request the switch to a free call period, during which the caller is not charged by the callee and not charged by the system. Thus, the fee status for a subsequent period of time can be changed from fee-based to free, and from free to fee-based. For example, the callee may use an interim free period to provide further introduction, sample, or incentive to the caller for service provided by the callee.

In one embodiment, a call package may have the continuation policy of “no longer charge” after the time for the call package is used up. During the free call period after the continuation of a paid package, the callee may further request a conversion back to a fee-based status. For example, the caller may be asked to purchase another call package or to continue on a per minute rate.

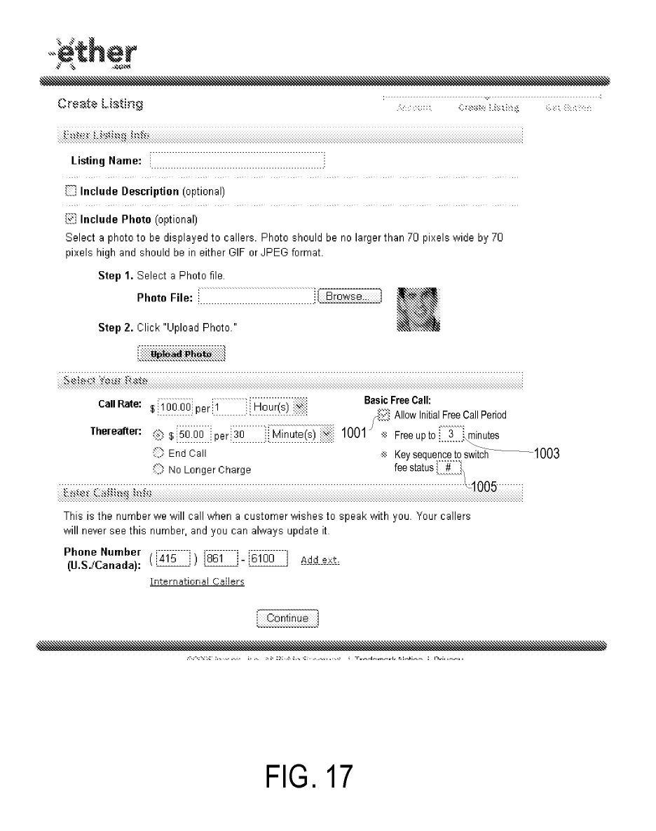

FIG. 17 illustrates a user interface to create a listing with an option to facilitate converting free calls to fee-based calls, according to one embodiment of the invention. In FIG. 17, the callee can specify whether or not to allow free calls from anonymous callers. If the callee would like to accept free calls, the callee can specify a particular key or a key sequence to switch the fee status of a period of communication during a call. For example, a free call may be converted into a fee-based call. The conversion may be for a specific period of the call. For example, the free call period may be followed by a fee-based call period and then followed by a further free call period, in response to the key sequence that is pressed to switch the fee status.

Alternatively, the entire call may be switched. For example, if the conversion from the free call is accept, the entire call including the initial period is converted to a fee-based call; otherwise, the call is terminated, free of charge to the caller.

In FIG. 17, the callee may use the checkbox (1001) to indicate to the system whether the callee allows an initial free call period. If the callee does not allow an initial free call period, a caller is required to accept the charge according to the call rate before being the real time communication between the callee and the caller is established. Otherwise, a caller may take advantage of the offer of an initial free call period, which may be used by the callee to provide free consultation to the caller.

In FIG. 17, the callee may further specify a time limit (1003) for the initial free call period. When the time limit (1003) for the initial free call period is reached, the system may automatically request the caller to accept the conversion. Before the time limit (1003) is reached, the callee may request the conversion by entering the key sequence (1005).

In one embodiment of the invention, a caller may specify the “#” or “*” key in the entry box as the key sequence that is used to convert a free call to a fee-based call. Accordingly, during a call, when the caller presses the selected key sequence, the system may prompt the callee to indicate whether the callee would like to continue the call on a fee basis. This allows the caller to be connected to the callee for free for an initial consultation or introduction. After the initial consultation or introduction, the callee can convert the free call to a fee-based call.

In one embodiment of the invention, the fee charged to the caller is based on the rate that the callee indicated during the setup process (e.g., as described in connection with the description of FIG. 2 above.) However, in an alternative embodiment of the invention, the fee may be determined during the free portion of the call, or between the free call period and the subsequent fee-based call period. Accordingly, the callee may be able to set the rate or fee by pressing keys on the dial pad. For example, in one embodiment of the invention, the callee may indicate the rate by pressing number keys on the dial pad that represent the rate in currency. Alternatively, the callee may press keys on the dial pad that represent pre-defined rate levels. For example, the callee may have previously established several rates and assigned each rate a level represented by a number. Accordingly, during the call, the callee may be prompted to select the number that represents the particular fee to be charged for that particular call.

Alternatively, the fee may be based on the purchase of a call package that has a pre-determined communication time limit.

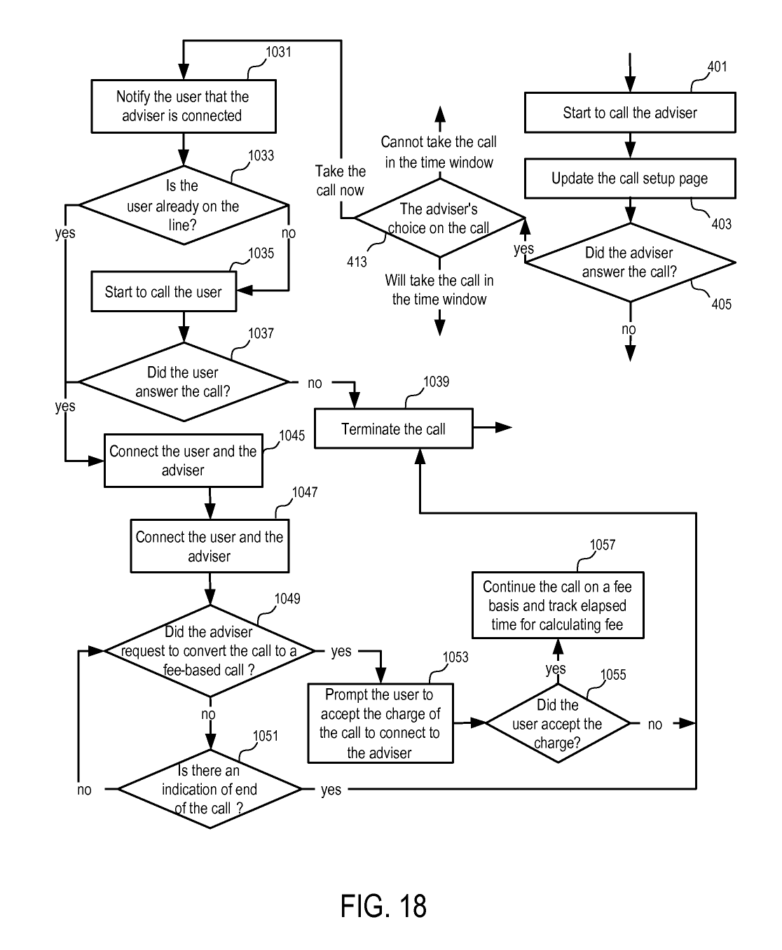

FIG. 18 shows an example of a flow diagram of a process to connect a user and an adviser for communication according to one embodiment of the present invention. Many of the operations illustrated in FIG. 18 may be the same or similar to those illustrated in FIG. 7.

In FIG. 18, after the system starts (401) to call the adviser, the system updates (403) the call setup page. For example, the system may play an animation and/or sound clip and/or a text message to indicate that the system is calling the adviser, in one embodiment.

Then, the system determines whether or not the adviser answered the call (405).

If the adviser answered the call, the system obtains the adviser's choice (413) on the call.

The adviser may indicate that the adviser wants to take the call now, in which case, the system notifies (1031) the user that the adviser is connected and the server is now calling the user (at which point of the process, the caller may or may not be on the phone). The system then determines if the user is already on the line (1033).

If the user is not already on the line, the system starts (1035) to call the user and determines whether the user answered the call (1037).

If the user did not answer the call back, the system terminates the call (1039).

If the user is already on the line or the user answers the call back, the user is on one line and the adviser on another line. In one embodiment, both the user and the adviser uses a telephone set connected to a circuit switched telephone network (e.g., PSTN). The system may initiate the call to the adviser and the call back to the user via a VoIP system, which may contain bridges to route the VoIP calls off the packet switched network and onto the circuit switched network. In one embodiment, the user and/or the adviser may receive the calls from the system on using a VoIP terminal of a VoIP system. In one embodiment, the user may initiate the call to the system using a VoIP terminal. A VoIP terminal may be a software program running on a computer or PDA, or dedicated VoIP phone.

After the system has connections to both the user and the adviser, the system then joins the connections to connect the user and the adviser (1045), but does not charge the caller for the initial connection. The system may charge the adviser (1045) for the initial connection for the free consultation or introduction period. At this point the user and the adviser can speak with one another, and make introductions.

During the call, if the adviser decides to convert the call from a free call to a fee-based call, the adviser can press a pre-defined key on the dial pad. For example, the adviser may press the “#” key to convert the call to a fee-based call.

If the adviser did not request the conversion and there is no indication of end of the call (e.g., both the adviser and the user remain on the line), the free call period continues.

If the adviser requested to convert the call to a fee-based call (e.g., to continue the call for a fee after the system detects the predefined indication, such as the pressing of the “#” key by the adviser), the system prompts (1053) the user to accept the charge to continue the call on a fee-basis.

If the user accepts the charge (1055), the system allows the call to proceed on a fee-basis (1057), and tracks the elapsed time of the call for purposes of calculating the proper fee.

If the user rejects the charge or fails to provide a response within a predetermined period of time, the system terminates (1039) the call. After the termination of the call, the system may update the user interface to show the reason for the termination.

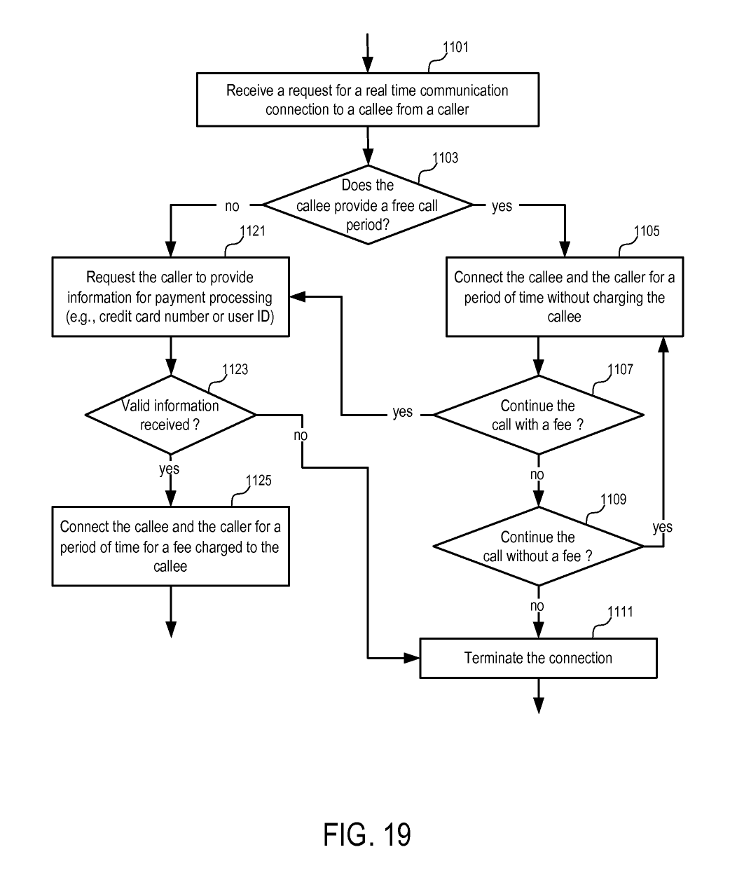

FIG. 19 shows another example of a flow diagram of a process to connect a user and an adviser for real time communication according to one embodiment of the present invention. In FIG. 19, after a request for a real time communication connection to a callee is received (1101) from a caller, it is determined (1103) whether the callee provides a free call period. The real time communication connection may be established for voice, audio, video and/or other multimedia channels, such as chat, instant messaging, document sharing, or screen-sharing, common “whiteboarding,” interactive TV or internet TV, etc.

If the callee allows free calls, the system connects (1105) the callee and the caller for a period of time without charging the callee. If it is determined that the free call is to be continued (1107) with a fee, the system requests (1121) the caller to provide information for payment processing, such as a credit card number or a user ID of the caller. If no valid information for payment processing is received (1123), the connection is terminated (or not established) (1111); otherwise, the system connects the callee and the caller for a period of time for a fee charged to the callee.

If the callee does not allow free calls (1103), the system requests (1121) the caller to provide information for payment processing before establishing the connection between the caller and the callee.

After the system connects (1105) the callee and the caller for a period of time without charging the callee, if it is determined that the free call is not to be continued (1107) with a fee and not to be continued (1109) without a fee, the system terminates (1111) the connection for the free call.

Thus, when the callee allows free calls, the system may postpone the processing of payment information to allow the caller to make a convenient call for a “taste” of the service, before deciding whether or not to purchase for a call package.

In one embodiment, the callee may change the preference of whether to allow the free calls substantially in real time. Thus, the callee may provide the offer of free call based on the availability condition of the callee and/or other considerations. Further, the callee may ask the system to determine whether or not to allow free calls. For example, the system may, based on statistical data, determine whether or not the allow free calls for a particular caller. For example, if the system determines that a caller is generally interested in buying such service when given a free period of consultation, based on user history information, the system may automatically grant the caller a request for a free call period. For example, if the system determines that a caller is generally not a serious buyer, the system may not provide the caller a free call period and thus to use the payment information processing as a filtering mechanism.

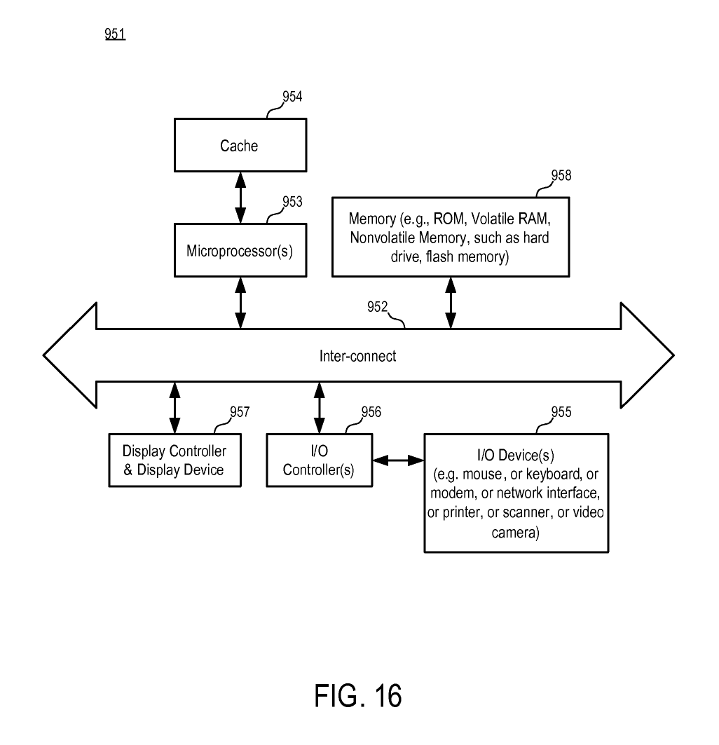

FIG. 16 shows a block diagram example of a data processing system which may be used with the present invention.

While FIG. 16 illustrates various components of a computer system, it is not intended to represent any particular architecture or manner of interconnecting the components. Other systems that have fewer or more components may also be used with the present invention.

In FIG. 16, the communication device (951) is a form of a data processing system. The system (951) includes an inter-connect (952) (e.g., bus and system core logic), which interconnects a microprocessor(s) (953) and memory (958). The microprocessor (953) is coupled to cache memory (954) in the example of FIG. 16.

The inter-connect (952) interconnects the microprocessor(s) (953) and the memory (958) together and also interconnects them to a display controller and display device (957) and to peripheral devices such as input/output (I/O) devices (955) through an input/output controller(s) (956). Typical I/O devices include mice, keyboards, modems, network interfaces, printers, scanners, video cameras and other devices which are well known in the art.

The inter-connect (952) may include one or more buses connected to one another through various bridges, controllers and/or adapters. In one embodiment the I/O controller (956) includes a USB (Universal Serial Bus) adapter for controlling USB peripherals, and/or an IEEE-1394 bus adapter for controlling IEEE-1394 peripherals.

The memory (958) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a server data processing system as illustrated in FIG. 16 is used as one of the communication server(s) (e.g., 929, 925, and/or 921 in FIG. 15).

Further, a user terminal as a client system can be a data processing system similar to the system of FIG. 16. A client system can be in the form of a PDA, a cellular phone, a notebook computer or a personal desktop computer. For example, the I/O devices of the user device may include a USB phone, a Bluetooth wireless phone, or one or more speakers or headphones with one or microphones for the implementation of a software based phone.

Alternatively, the traditional communication client(s) may be used in some embodiments of the present invention.

From this description, it will be appreciated that certain aspects of the invention are embodied in the user devices, certain aspects of the invention are embodied in the server systems, and certain aspects of the invention are embodied in a system as a whole.

Embodiments of the present invention can be implemented using hardware, programs of instruction, or combinations of hardware and programs of instructions.

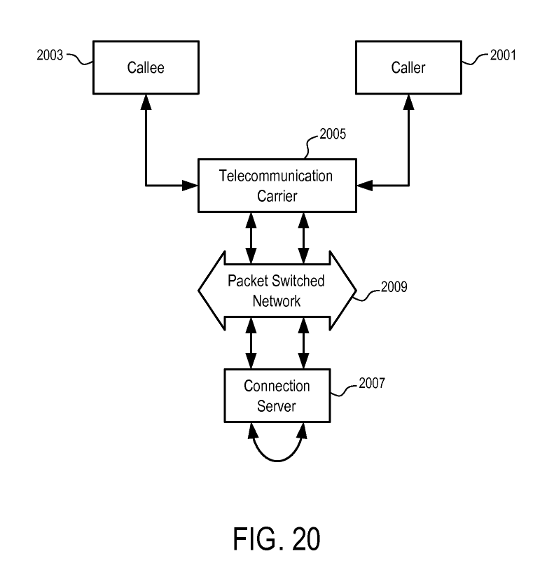

In one embodiment, a connection provider uses a connection server configured on a packet switched network to provide telephone connections between callers (e.g., customers) and callees (e.g., advertisers), as illustrated in FIG. 20. In FIG. 20, the connection server (2007) receives and/or places telephone calls via the telecommunication carrier (2005) over the packet switched network (2009). The telecommunication carrier (2005) further routes the telephone communications towards the caller (2001) and the callee (2003).

Since the telecommunication carrier (2005) can route a call from a packet switched network to a variety of destinations (e.g., a traditional analog telephone set, a mobile phone, a cellular phone, a WiFi phone, a Bluetooth phone, a softphone running on a computer, etc.), the connection sever (2007) can use one type of communication connection with the telephone carrier (2005) to facilitate the communication connections with variety of devices used by the customers (e.g., callers and callees). Thus, the implementation of the connection server (2007) can be simplified. In one embodiment, the connection server (2007) can also place and/or receive direct VoIP calls to/from the caller (or callee).

For example, to make a voice connection in response to a click-to-call request, the connection server can place separate VoIP calls, via the telecommunication carrier (2005), to the caller (2001) (e.g., the requester of the click-to-call) and the callee (2003) (e.g., the destination of the click-to-call request).

If the caller (2001) (or the callee 2003) is on a public switched telephone network (PSTN), the telecommunication carrier (2005) bridges the packet switched the network and the public switched telephone network (PSTN). The telecommunication carrier (2005) routes the call from the packet switched network (2009) to the caller (2001) (or the callee 2003) on the circuit switched network. Thus, the caller (2001) (or the callee 2003) can use a telephone set to receive the call via a Plain Old Telephone Service (POTS). The connection server (2007) joins the separate calls that are placed via the packet switched network (2009) to connection the callee (2003) and the caller (2001).

In one embodiment, call signaling and media content may use different network paths. While call signaling is arranged to go through the packet switched network (2009) and the connection server (2007), the media stream does not have to go through the connection server (2007). For example, when the calls are joined, the media content may be redirected to flow over the communication carrier (2005) without going through the packet switched network (2009) to the connection server (2007) for improved performance and efficiency. The connection server (2007) can release the control over the media stream to allow the media stream to flow through the shortest path, without going through the connection server, while maintaining control to the connection for the call by staying on the path for call signaling.

In another example, when the caller (2001) initiates a call over a PSTN to the connection server (2007), the telecommunication carrier (2005) converts the call for the packet switched network (2009) for the connection server (2007).

In one embodiment, virtual softphones on the telecommunication carrier (2005) are assigned to the caller (2001) and the callee (2003) for interfacing with the connection server (2007) over the packet switched network (2009). The virtual softphones encapsulates the devices and networks used by the caller (2001) and callee (2003) to access the connection server (2007); and the telecommunication carrier (2005) shields the connection server (2007) from the implementation details of the user devices and networks used by the caller (2001) and the callee (2003). The connection server (2007) calls (or receives calls from) and connects the virtual softphones on the telecommunication carrier (2005) to connect the caller (2001) and the callee (2003).

In FIG. 20, the telephone connection between the telecommunication carrier (2005) and the connection server (2007) is facilitated via a packet switched network (2009). Thus, the connection server (2007) can operate efficiently in a digital domain. The connection server (2007) interfaces with the telecommunication carrier (2005) using one type of Internet Telephony systems (e.g., SIP-based Internet telephony).

Alternatively, a connection server may include some or all of the functionality of the telecommunication carrier (2005). For example, the connection server may be configured to bridge a packet switched network and a circuit switched network. The connection server may support multiple, different types of Internet Telephony systems.

In one embodiment, the connection server (2007) and the telecommunication carrier (2005) are operated by different, separate entities. Alternatively, the connection server (2007) and the telecommunication carrier (2005) may be operated by the same entity. In another embodiment, the telecommunication carrier (2005) includes a set of facilities operated by a number of separate entities.

In one embodiment, the caller (2001) and/or the callee (2003) may also place/receive calls via a packet switched network. The telecommunication carrier (2005) may route the calls between the caller (2001) and the callee (2003) without using a PSTN. In one embodiment, caller (2001) and/or the callee (2003) may place calls to or receive calls from the connection server (2007) via Internet.

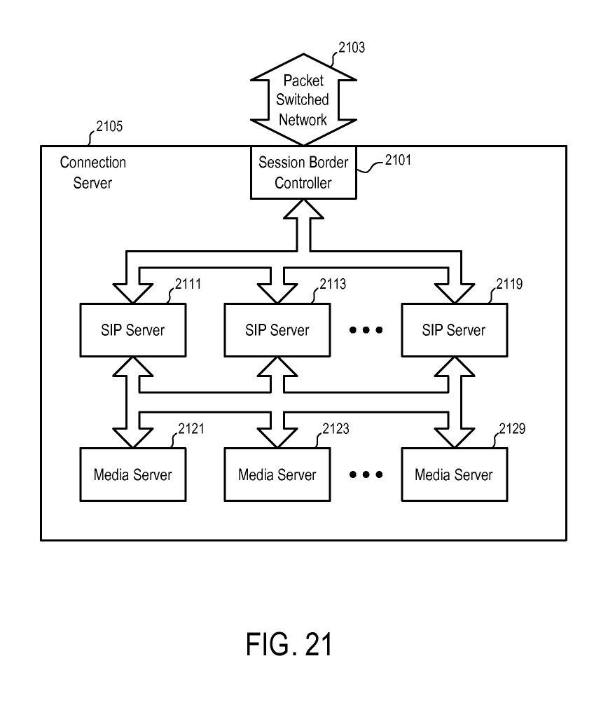

FIG. 21 shows a connection server according to one embodiment. In FIG. 21, the connection server (2006) is configured to place and/or receive VoIP calls using Session Initiation Protocol (SIP). A session border controller (2101) is used to interface with the packet switched network (2103) and control the types of network traffic related to VoIP calls that might go into the connection server (2105).

In one embodiment, the session border controller (2006) is configured to control the signaling and media stream during the setting up, conducting and tearing down of VoIP calls to or from the connection server (2105). In some embodiments, the session border controller (2006) may pick up the call that comes to the session border controller (2006), places a separate call from the session border controller (2006), and joins the received call and the placed call to control both the signaling and media stream. In some embodiments, the session border controller (2006) may perform signaling/encoding translation to allow the connection server (2105) to process the VoIP calls in one standard, while receiving VoIP calls in a variety of standards (e.g., SIP, H.323, etc.). In one embodiment, the session border controller (2006) is configured to perform one or more firewall functionalities, such as denial of service protection, call filtering, bandwidth management, etc.

In one embodiment, the session border controller (2006) is configured to perform media releasing operation. When the session border controller (2006) determines that the source and destination of a media stream is on the same side of the session border controller (2006) (e.g., both the source and the destination of the media stream is outside the connection server 2105), the session border controller (2006) can release the hairpinning of the media stream and allow the media stream to flow without going through the session border controller (2006).

In FIG. 21, a set of SIP servers (e.g., 2111, 2113, . . . , 2119) are networked to the session border controller (2101) to receive messages for incoming calls and to initiate outgoing calls. The session border controller (2101) is configured to evenly distribute the calls for processing by the SIP servers.

For example, when an incoming message for the initiation of a call is received (e.g., a SIP INVITE message from the telecommunication carrier 2005), the session border controller (2101) may route it to a SIP server (e.g., 2111) for processing. The INVITE message includes the phone number dialed by the caller and the contact information about the caller (e.g., the phone number of the caller 2001 and/or the identity of the virtual SIP phone at the telecommunication carrier 2005).

The SIP server may determine whether the phone number dialed by the caller (2003) is sufficient to determine the phone number of the callee (e.g., 2003). If the phone number of the callee (e.g., 2003) can be determined from the phone number dialed by the caller (2003) (e.g., via decoding the phone number dialed by the callee, or looking up the phone number of the callee from a table using the phone number dialed by the caller as a key), the SIP server can place a separate SIP call to the callee via the packet switched network (2103) and then connect the caller and the callee. Alternatively, the SIP server can further route the SIP INVITE message (e.g., to the telecommunication carrier (2005) to direct the call to the callee. For example, the SIP server may modify the INVITE message by replacing the destination with the determined phone number of the callee. Further, the SIP server can modify the INVITE message by removing the phone number of the caller (or replacing the phone number of the caller with a phone number of the connection server). In one embodiment, the modified INVITE message identifies the virtual softphone corresponding to the caller on the telecommunication carrier as the SIP phone initiated the call; thus, the virtual softphone corresponding to the callee on the telecommunication carrier can establish media connection with the virtual softphone corresponding to the caller on the telecommunication carrier directly. Alternatively, the modified INVITE message may identifies a media server (2121) (or a virtual softphone on SIP server) as the initiator for a separate call. The SIP server then connects the calls for the media stream.

In one embodiment, the caller is first connected to a media server (e.g., 2121, 2123, or 2129). For example, the SIP server may forward the SIP INVITE message to one or more of the media servers for answering the call. When a media server (e.g., 2121) answers the call, a prompt is played to the caller by the media server. The media server may include an Interactive Voice Response (IVR) system, or be connected to an IVR system, to obtain input from the caller.

For example, the media server may prompt the caller to enter the extension assigned to the callee, such that the phone number of the callee can be determined based on the phone number including the extension dialed by the caller. In some embodiments, the extension dialed by the caller is sufficient to determine the phone number of the callee. After the phone number of the callee is determined, the SIP server can further connect the call to the callee.

For example, the media server can send a message to the SIP server. The message identifies the call and the extension obtained from the caller. The SIP server then determines the callee's phone number based at least on the extension received from the media server and initiates a SIP call via the packet switched network (2103) (e.g., by sending a SIP INVITE message to the telecommunication carrier 2005, which further bridges the call to the callee 2003). Then, the SIP server disconnects the media server from the call and reconnects the call to the callee.

For example, the SIP server can send a SIP BYE message to the media server to disconnect the media server from the call (e.g., by sending a “BYE” message to the media server for the call) and send a re-INVITE message towards the caller to connect the caller and the callee. Alternatively, the media server may send a SIP BYE message to the SIP server for the call; the BYE message may include the extension obtained from the caller; in response to the BYE message that contains the extension, the SIP server determines the phone number of the callee and further connects the caller to the callee.

In one embodiment, the SIP server can direct the caller and the callee to connect to each other for the media stream without having the media stream going through the session border controller (2101) into the connection server (2105). For example, the media stream can go through the telecommunication carrier (2005) in FIG. 20 without going to the connection server (2007) after the SIP server connects the caller and the callee.

However, the SIP server stays on the signaling path to monitor the progress and termination of the call. The SIP server can also break the connection between the caller and the callee, or force the media stream to come through the connection serve (2105). For example, the SIP server may selectively conference a media server into the call to monitor and/or record the communication of the call between the caller and the callee. For example, the SIP server may reconnect the caller and the callee to separate media servers for interaction with an IVR system or a human operator to confirm a deal or transaction.

Similarly, the SIP server may initiate a callback to a caller via a SIP call over the packet switched network (2103) for a connection to the caller. The SIP call may be bridged onto a circuit switched network (e.g., by a telecommunication carrier 2005). The SIP server can then reconnect the call to a media server for sending a prompt to the caller before reconnect the call to the callee. Alternatively, the callback can be initiated from a media server; and the call signaling (e.g., the INVITE message from the media server) goes through the SIP server for call control. Alternatively, the SIP server sends out the INVITE message on behalf of the media server.

In one embodiment, the SIP servers (2111, 2113, . . . , 2119) and media servers (2121, 2123, . . . , 2129) are implemented on separate computers connected via a local area network (and/or intranet or Internet). Alternatively, at least the some of the servers can be implemented on a same computer. In one embodiment, the SIP servers and the media servers are also integrated with the session border controller (2101) on a same data process system having multiple processors coupled with a data bus. In one embodiment, the SIP servers are coupled to the media servers via a network; and a SIP server may use any of the available media server for interaction with the caller (or callee). Alternatively, a SIP server may be configured to use one or more of media servers that are not shared by other SIP server. For example, a SIP server may be implemented on a same data processing system with one or more media servers which are reserved for the SIP server.

In one embodiment, the connection server (2105) may further include a database server (2105) to storing records related to the calls, data mapping between the communication references assigned to the callees and the actual phone numbers of the callees, etc. In one embodiment, contact mapping are cached in the local memory (e.g., RAM) of the servers for improved performance; and the cached mapping is updated when the database is updated.

In one embodiment, a communication platform is provided to allow people to sell services by seamlessly changing the means of communication, such as voice, chat, email, etc.

In one embodiment, multimedia communication connections are provided between a seller and a buyer in a communication session. The communication session allows the seller and the buyer to communicate with each other in person and in real time. In one embodiment, the communication session may dynamically switch from text chat to voice chat to video conferencing and/or to other types of communications, such as document sharing, screen sharing, common whiteboarding, etc., in response to user requests.

In one embodiment, a system is provided to facilitate the transition from the free communication connection between the seller and buyer to fee based commerce in which services, such as information, entertainment, amusement, advice, etc., can be delivered for a fee over the communication connection for a fee. For example, the seller may use the free communication connection to provide an introduction, to provide a taste of the service, to provide description, comments or answers that address the concerns of the buyer, etc. The seller can then request the conversion from the free communication connection to a fee-based service that is at least partially provided over the communication connection. In some embodiments, the product and/or service offered by the seller is not delivered via the communication connection; however, payment processing is performed by the connection provider to facilitate the transaction between the seller and the buyer.

In one embodiment, the connection provider processes payments on behalf of the seller and thus lifts the burden from the seller. The connection provider can identify the seller and the buyer based at least in part on the identification and/or authentication of the entities for the establishment of the communication session. An authentication can be performed via a visual user interface (e.g., a web page, a dialog box), or via the voice connection based on a phone number and a pin number. The capability of the connection provider to charge users for the communication services can be used to facilitate commerce that is based on communication connections.

In some embodiments, the seller may offer for sale, or conduct an auction of, a item that may not be delivered via a communication connection, such as a physical merchandise. The communication connection can be provided and used for real time, in person communications that might lead to the sale. The communication session can be used for confirmation of a sale and/or for payment processing.

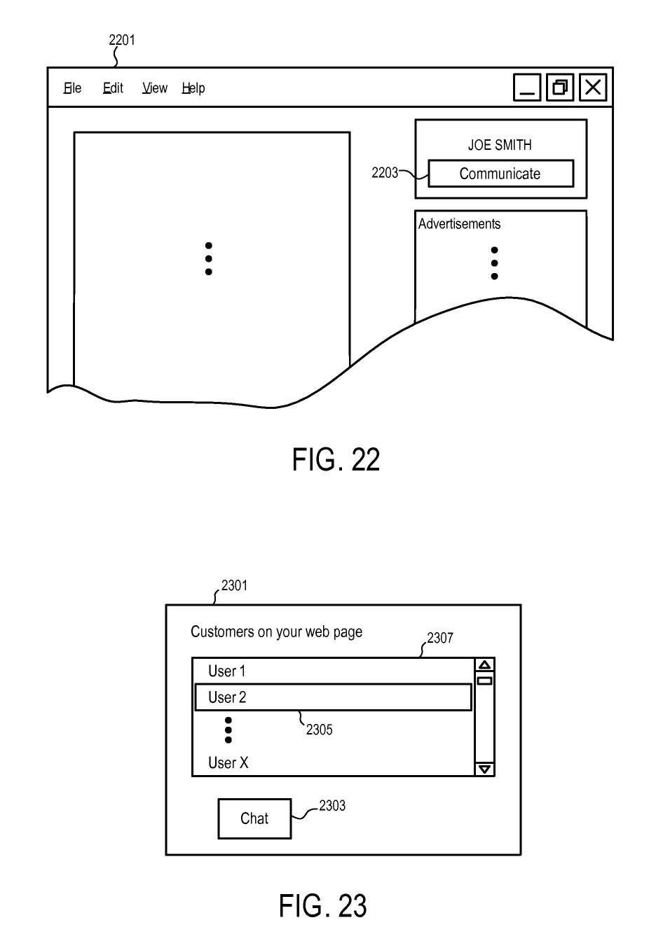

FIGS. 22-30 illustrate examples of providing connections for real time, in person communications and facilitating commerce over the communication connections according to one embodiment.

In FIG. 22, a communication reference (2203) is provided to identify the communicatee (e.g., Joe Smith). The communication reference (2203) can be used to request for a communication session with the communicatee.

In one embodiment, the communication reference (2203) includes a link to a web site of a connection provider, which when rendered in the browser (2201) causes the connection provider to show an iconic representation (e.g., a button) of the communication reference (2203).

In one embodiment, to generate the iconic representation the connection provider uses information that indicates the real time availability of the communicatee to engage in the real time communication. For example, different appearances of communication reference (2203) can be generated based on different statuses of real time availability of the communicatee.

Alternatively, the communication reference (2203) may have a static appearance that does not change with the real time availability status of the communicatee.

In one embodiment, the user of the browser (2201) explicitly requests a communication session with the communicatee by selecting the communication reference (2203) (e.g., clicking the iconic representation (2203)). In response to the user selection of the communication reference (2203), the browser (2201) sends a request for a communication session to the web site of the connection provider.

In another embodiment, the user of the browser (2201) can implicitly request the communication session via loading the communication reference (2203) for display. For example, when the communication reference (2203) is loaded for display, the browser (2201) sends a request to the web site of the connection provider for an updated appearance of the communication reference (2203), which implicitly requests for a communication session with the communicatee.

In one embodiment, when the request for the communication session is received at the connection provider (e.g., via the web site of the connection provider), the communicatee is informed of the request that has been received from the user of the web browser.

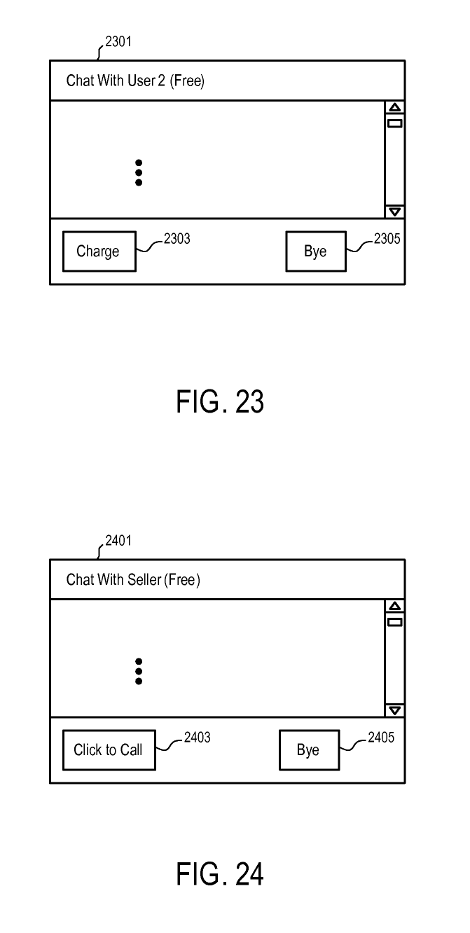

For example, in FIG. 23, the interface (2301) shows the list of users who implicitly or explicitly requested the communication session with the communicatee (e.g., seller). Using the interface (2301), the communicatee can select a user (2305) from the selection box (2307) and press the button (2303) to request a text chat connection with the selected user.

In one embodiment, to provide privacy to the seller and the buyer, the chat connection between the seller and the buyer is provided via bridging a connection between the seller and the connection provider and a connection between the buyer and the connection provider. Thus, the identity of the seller is shielded from the buyer; and the identity of the buyer is shielded from the seller. Other types of communication connections, such as voice, video, application sharing, screen sharing, document sharing, etc., can also be provided via the connection provider bridging separate connections to the buyer and the seller.

In one embodiment, the seller and/or the buyer can select one or more connection types from a variety of available connection types, such as text chat, voice chat/telephone connection, video, application sharing, screen sharing, document sharing, common whiteboarding, etc. The communication session may switch from one communication connection to another, and/or to add or remove a selected communication connection.

In one embodiment, the seller, or the buyer, can start the session with a text chat window, which can be upgraded to voice (or video, and/or other connection types).

In one embodiment, the connection provider identifies the communicatee (seller) based on the communication reference (2203) that is assigned to represent the communicatee (seller). The seller is authenticated before being presented with the user interface (2301), which can be implemented as a portion of a web page presented to the seller, or as a standalone application program. The authentication can be performed via a visual user interface (e.g., a web page, a dialog box of a standalone application program) or an audio interface (e.g., an IVR system, or a human operator).

In one embodiment, the connection provider can authenticate the user of the browser (2201) based on a variety of information sources, such as the IP address of the browser (2201), identification information stored with the browser (2201) (e.g., ID information stored in a cookie maintained by the browser (2201)), user ID and password submitted by the user of the browser (2201) after the button (2203) is selected, a phone number and pin, etc.

In one embodiment, the communicatee (seller) is provided with a tool to manage the information about the customers. For example, the seller can assign nick names to the customers without obtaining the real names of customers from the connection provider. For example, the seller can store notes about the customers, based on information obtained from prior communications with the customers. For example, based on prior experience with the customers, the seller may designate different priority ranks to the customers.

In one embodiment, after the connection provider identifies the user of the browser, information saved by the seller in relation with the user can also be displayed to help the seller in prioritizing the connections with the customers. For example, when the user (2305) is selected, information saved by the seller in relation with the user (2305) can be displayed, such as whether the user (2305) is a VIP customer, prior transactions with the user (2305), nick name of the user (2305) that was assigned by the seller, etc.

In one embodiment, when the chat connection between the communicatee (seller) and the user (buyer) is established, the user interfaces (2301 and 2401) as illustrated in FIGS. 23 and 24 are presented to the seller and the buyer respectively.

In one embodiment, the buyer can request an upgrade from the text-based communication connection to a voice-based communication connection via the “click to call” button (2403) displayed in the user interface (2401).

In one embodiment, when the “click to call” button (2403) is selected, an instant messaging connection that supports real time voice communication is established between the seller and the buyer.

In another embodiment, when the “click to call” button (2403) is selected, a request for a telephone connection is sent to a connection provider, which then calls back the buyer at a phone number specified by the buyer and calls the seller at a phone number specified by the seller to establish a telephone connection between the seller and the buyer.

The buyer and the seller can specify the telephone numbers in their account profiles. For example, after the buyer and the seller are identified/authenticated, the connection provider can look up the telephone numbers of the seller and the buyer from data maintained in their accounts. Alternatively or in combination, the connection provider can prompt the seller and/or the buyer for the telephone numbers that can be used for establishing the telephone connection.

In one embodiment, the voice connection made via the “click to call” button (2403) is in additional to the existing text-based chat connection. Thus, the seller and the buyer can use the concurrent text connection and voice connection for real time, in person communications.

In another embodiment, after the voice connection is established, the text connection is terminated; and user interfaces are updated for the seller and the buyer to show the progress and/or the status of the voice connection.

The seller and the buyer can use the “bye” buttons (2305 and 2405) displayed in the user interfaces (2301 and 2401) to end the connection for text-based chat.

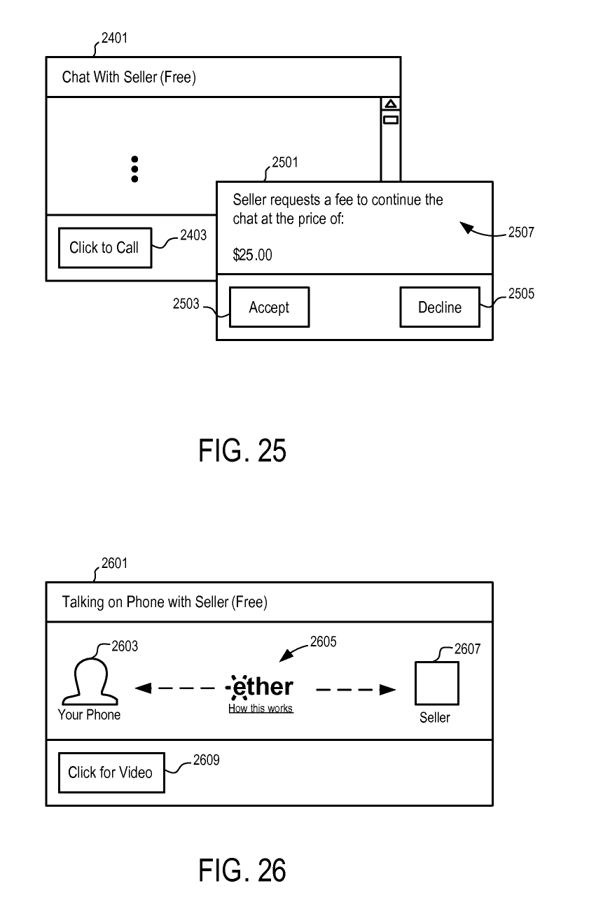

In one embodiment, the connection for text chat is free of charge for both the seller and the buyer. When the seller decides to charge the buyer for the text-based real time communication, the seller can select the “charge” button (2305) displayed in the user interface (2301). When the “charge” button (2305) is selected, a request is sent to the connection provider, which then prompts the buyer to accept the charge, as illustrated in FIG. 25.

In FIG. 25, the user interface (2501) displays a message (2507) to inform the buyer about the offer of the seller. For example, the seller may request a fee to continue the chat at a fixed price (e.g., $25.00), which is independent on the duration of the communication. Alternatively, the seller may specify a price that is based at least in part on the duration of the communication. For example, the fee may be proportional to the duration of the fee-based communications (e.g., $50.00 per hour); alternatively, the fee may be based on a pre-defined time limit for the fee-based communications (e.g., $25.00 for no more than 20 minutes of fee-based communications).

In one embodiment, a seller may terminate a fee-based communication period and restart a period of free communications. In one embodiment, after the expiration of a time limit for fee-based communication, the buyer is no longer charged; alternatively, the buyer can be prompted to make another purchase after the expiration of the time limit.

In one embodiment, when the user interface (2501) illustrated in FIG. 25 is displayed to prompt the buyer to accept the price, the communication connection for the chat interface (2401) is temporarily disconnected or put on hold. When the buyer selects the “accept” button (2503), the communication connection is reconnected; and the buyer and the seller can continue the conversation.

Alternatively, the buyer can continue using the chat interface to communicate with the seller while the user interface (2501) is displayed to prompt the buyer to accept the price. In one embodiment, if the buyer fails to select the “accept” button (2503) within a pre-defined period of time, the “decline” button (2505) is automatically selected.

In one embodiment, when the buyer declines the offer, the communication session between the seller and the buyer is closed by the connection provider. Alternatively, the connection provide can inform the seller that the buyer declined the offer; and the seller can subsequently determine whether to close the communication session with the buyer, or to continue the conversation with the buyer for free for another period of time, or to modify the offer.

In one embodiment, the price and/or the offer are specified by the seller before the communication session. In response to the seller selecting the “charge” button (2305), the connection provider can look up the price and present the message (2507) to prompt the buyer to accept the offer.

In another embodiment, the price and the offer can be specified by the seller during the communication session. For example, the seller and the buyer may negotiate the price and the offer using the communication connection provided by the connection provider; when the seller selects the “charge” button, a user interface (not shown) displayed to the seller can be used to receive the information about the price and the offer, based on which the connection provider can generate the message (2507) to prompt for the acceptance of the offer, charge the buyer and compensate the seller accordingly after the offer is accepted by the buyer.

Alternatively, an interface (not shown) can be presented to receive the information about the price and offer, during the communication session, before the seller selects the “charge” button (2305).

FIG. 26 illustrates an interface (2601) showing the process of a voice connection after the buyer selects the “click to call” button (2403). In FIG. 26, iconic representations of the buyer (2603), the seller (2607) and the connection provider (2605) are presented to illustrate the connection process. The graph presented in the interface (2601) illustrates that the connection provider (2605) makes separate connections to the seller (2607) and the buyer (2603) to connect the buyer and the seller. In one embodiment, the status of the separate connections are illustrated graphically. For example, broken lines can be used to indicate the connections to be established; and solid lines can be used to indicate established connections.

In FIG. 26, a “click for video” button (2609) is displayed together with the graph that illustrates the progress of the voice connection. The buyer can request an upgrade to video by selecting the “click for video” button (2609).

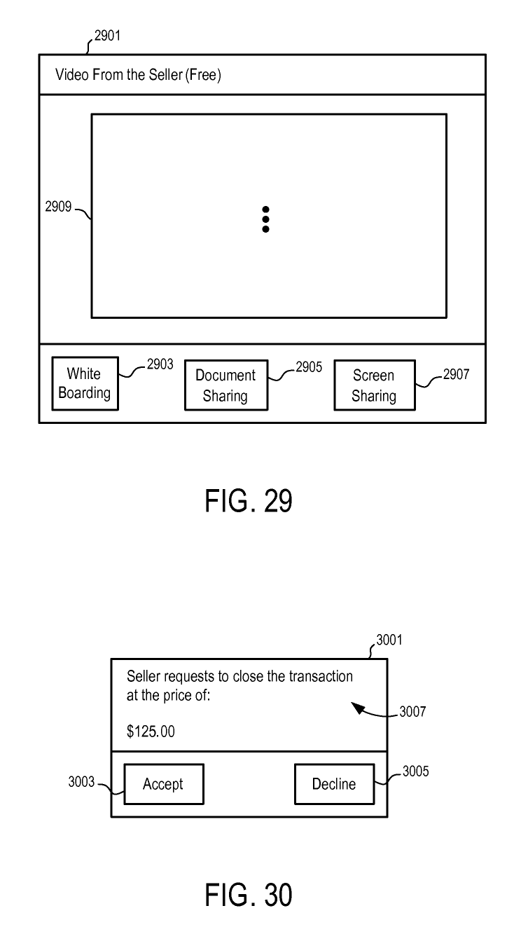

In one embodiment, after the “click for video” button (2609) is selected, the connection provider causes a live video stream to be transmitted from a video camera to a video interface (e.g., 2901 in FIG. 29) presented to the buyer. In one embodiment, the video stream is provided in addition to the text and/or voice connection. Thus, the seller can present information and/or products via the video connection provided in the communication session.

In one embodiment, a one-way video stream from the seller to the buyer is provided when the “click for video” button (2609) is selected. In another embodiment, a two-way video connection is provided between the seller and the buyer to allow the buyer to see the video from the seller and the seller to see the video from the buyer. In a further embodiment, a buyer may provide video input to the seller without obtaining video information from the seller.

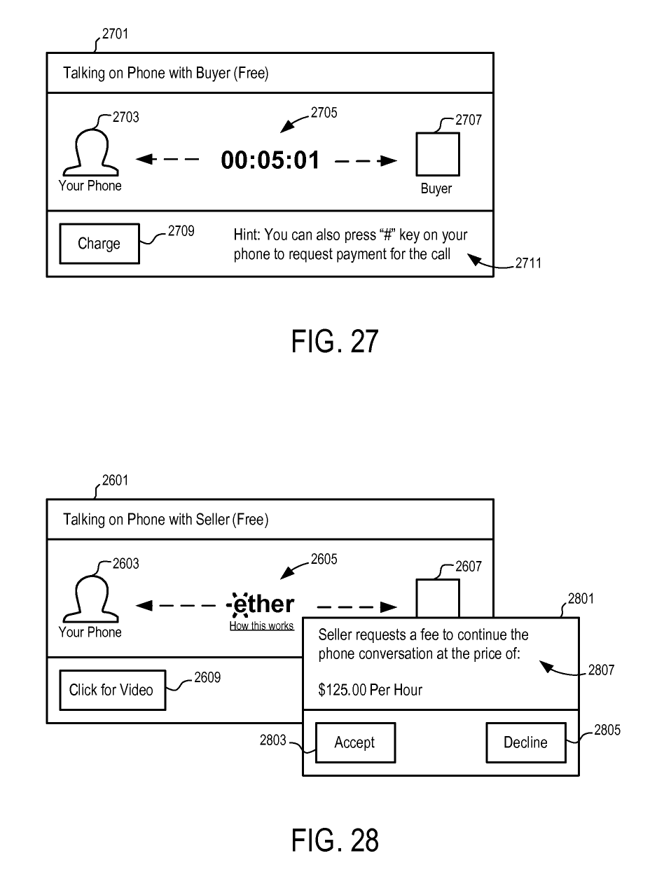

FIG. 27 illustrates an interface (2701) showing to the seller the process of a voice connection after the buyer selects the “click to call” button (2403). The graph displayed in the interface (2701) includes an iconic representation of the seller (2703) and the buyer (2707). The accumulated time period of the voice connection is displayed (2705) and updated periodically.

In FIG. 27, a “charge” button (2709) can be selected by the seller to request the connection provider to charge the buyer for communicating with the seller over the voice connection. The interface (2701) also provides a message (2711) which indicates that the seller can request the connection provider to charge the buyer by pressing the “#” key on the phone. In one embodiment, the connection provider monitors the communication and detects the predefined key sequence (e.g., “#” or “*99”) which indicates the seller's request for payment.

For example, after the seller selects the “charge” button (2709), or after the seller presses the “#” key to request payment, the connection provider presents an interface (2801) to prompt the buyer to accept the price, as illustrated in FIG. 28.

In FIG. 28, a message (2807) describes the offer of the seller and the price. For example, the seller may offer to continue the phone conversation at a given price (e.g., $125.00 per hour). The buyer may use buttons (2803 and 2805) to accept or decline the offer.

FIG. 29 illustrates an interface (2901) that displays a video stream obtained from the seller. The video is presented in the window (2909); and a set of buttons (2903, 2950, and 2907) can be used by the buyer to further request connections for other types of communications, such as whiteboarding, document sharing, and screen sharing.

In one embodiment, the seller may request the connection provider to charge the buyer separately for different types of communications, such as text, voice, video, etc. In another embodiment, the price charged is based on the time duration of the communication session.

In one embodiment, the fee-based portion of the communication session starts after the buyer accepts the charge. In another embodiment, after the buyer accepts the charge, the entire communication session, including the time period leading to the acceptance of the charge, becomes fee-based.

In one embodiment, the product or service offered by the seller can be delivered over the communication connections provided by the connection provider. In another embodiment, the seller may also offer for sale of a physical merchandise or a service that cannot be delivered via the communication connections. However, the communication connections can be used to facilitate the discussion of the transaction. During the communication session, the seller can specify the offer in a user interface provided by the connection provider; and the connection provider can then prompt the buyer to accept the offer, as illustrated in FIG. 30.

In FIG. 30, the interface (3001) includes a message (3007) describes the offer and the price. The buyer can accept or decline the offer using the buttons (3003 and 3005). In one embodiment, the connection provider starts to process payment when the buyer selects the “accept” button (3003). For example, the connection provider can charge the member account of the buyer, or a digital wallet of the buyer, or a credit card account of the buyer, or other financial accounts of the buyer, to close the transaction.

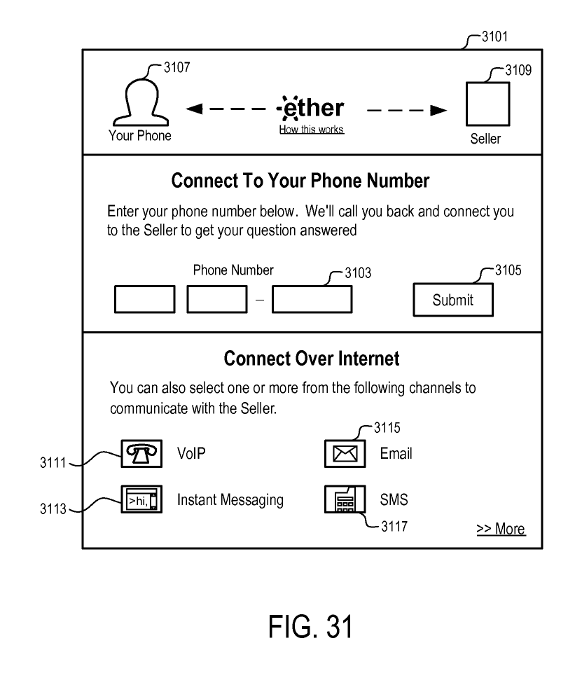

In one embodiment, multiple interfaces for different types of communication connections (e.g., text, voice, video, application sharing, screen sharing, etc.) can be provided concurrently to allow multi-media interaction between the seller and the buyer. FIG. 31 illustrates examples of multimedia communication connections according to one embodiment.

In FIG. 31, the call graphic (3101) shows a graphical representation of the customer (3107), a graphical representation of the seller (3109) (e.g., communicate/callee), and a graphical representation of the connection statuses (3102) between the system and the seller (3109) and between the system and the customer (3107).

In FIG. 31, the customer can choose to request a voice connection via a callback to a phone number provided by the customer. The customer is prompted to provide a callback phone number in the text entry box (3103). If the customer provides the callback phone number and selects the “Submit” button (3105), the system will call back the customer at the phone number provided in entry (3103) and call the seller based on a reference embedded in the call graphic (3101) to make a phone connection between the customer and the seller. In one embodiment, the reference embedded in the call graphic (3101) is inherited from the call button that was selected to initiate the call graphic (3101).

In one embodiment, the customer can further specify a time window for the callback (similar to that shown in FIG. 3 but not shown in FIG. 31).

In addition to the offer to make a phone connection to a user specified phone number compatible with a Plain Old Telephone System (POTS) via a callback, the call graphic (3101) illustrated in FIG. 31 allows the customer to request alternative or additional concurrent connections via other media channels, such as VoIP telephony (3111), Instant Messaging (3113), Email (3115), SMS (3117), etc.

In one embodiment, the icons (e.g., 1011, 1013, 1015, 1017, etc.) can be selected to request the respective connections. For example, when the VoIP telephony (3111) is selected, an VoIP client application is launched to establish a connection between the system and the customer; and the system can further bridge the VoIP-based connection to the seller over a voice connection of choice by the seller (e.g., a connection to a POTS compatible phone number, voice-based instant messaging, etc.).

In one embodiment, the customer can use the interface (3101) to switch from one voice connection to another. For example, after the customer is connected to the seller via VoIP (3111) on a softphone, the customer may want to switch the voice connection to a landline phone or a mobile phone. The customer may provide the callback phone number in the entry box (3103) and presses the submit button (3105). After the customer picks up the callback (e.g., on the landline phone or a cellular phone), the customer may hang up the softphone and continue the conversation on the landline phone or a cellular phone, or use both the connections for voice communication. For example, the customer may initiate the callback request to ask another person to join the voice conversation. Alternatively, the connection provider may disconnect the connection for the softphone after the customer picks up the landline phone or the cellular phone.

In one embodiment, after the customer uses the entry box (3103) and the submit button (3105) to request a callback to a landline phone, the customer may wish to transfer the connection to a cellular phone. Thus, the customer may use the entry box (3103) and the submit button (3105) to request a second callback to the cellular phone. After the connection to the cellular phone is established, the customer is prompt to hold the cellular phone and hang up the landline phone to switch the connection over to the cellular phone. Once the customer hangs up the landline phone, the cellular phone is connected to the seller. Alternatively, the cellular phone and the landline phone can be connected with the seller in a telephone conference for a predetermined period of time (e.g., one minute), or until the customer hangs up either the cellular phone and/or the landline phone.

In one embodiment, the customer can request for the transfer of a voice connection via the phone. For example, when the customer is connected to the seller via a landline phone, the customer may press “*” to request the connection provider to switch the connection to another phone. For example, the customer may enter the phone number of a mobile phone after pressing “*” to request a transition to the mobile phone or to add another landline phone to the phone conference. The customer may enter the phone number via the keypad, or via an interactive voice response (IVR) system or a human operator.

In one embodiment, a seller can also request the connection provider to switch voice connection and/or add additional connections for teleconferences in ways similar to those described above (e.g., via a call graph interface or via phone).

In one embodiment, after the customer requests an additional connection, the seller is notified the change and provided with the opportunity to request a payment or a modified price. For example, the seller may be provided with a graphical user interface which notifies the change and accepts input for a payment request and/or a new price; alternatively, the seller may be connected temporality to an IVR system to receive the notification; alternatively, the seller may be notified via an SMS, email, or instant message.

For example, when the Email icon (3115) is selected, a web form may be presented to receive input for an email message. Alternatively, an email client program is launched to send an email to the system; and the email is then forwarded to seller via an choice of the seller. For example, the seller may choose to receive non-real time text communications via email, or SMS, or a web-based messaging system. In one embodiment, when the Email icon (3115) is selected, a further call graphic is displayed to prompt the customer to select a preferred way to compose and send the electronic message to the seller via the connection system.

In one embodiment, the system can establish the media channels with the customer and with the seller separately and bridge the media channels to facilitate the communications. For example, the system can establish an instant messaging session with the customer and an instant messaging session with the seller and relay the messages between the two instant messaging sessions to facilitate instant messaging between the seller and the customer. The customer and the seller may be used the same instant messaging network or different instant messaging networks. In one embodiment, the customer and the seller can used instant messaging clients with different communication protocols; and communication protocol translation is performed by the system (e.g., using a software robot (Bot)) to bridge the connections.

In one embodiment, a customer may select multiple communication channels (e.g., an instant messaging session for text-based chat and a callback to POTS phone number for voice chat) and then the “Submit” button (3105) to request simultaneous connections of the different communication channels. Alternatively, the customer may start with one communication connection (e.g., for voice communication) and then request another connection (e.g., for text and/or video communications) subsequently, or when needed.

For example, the customer may start with a request for a phone connection via a callback. During the connection, if the customer wishes to send text to the seller, the customer may further request an email connection, an SMS connection, or an instant messaging connection.

In another example, the customer may start with a text-based instant messaging connection, during which it may be determined that a voice connection is needed. Thus, the customer may further request a concurrent voice connection, which can be established via a callback, or via a voice-based instant messaging connection.

In one example, the customer may start with a channel for non-real time communications (e.g., email or SMS) and then switch to a channel for real time communications.

In one embodiment, the system can provide protocol and/or format conversion/transformation to bridge the connection to the customer and the connection to the seller. For example, the system may use one protocol/format for a connection with a customer and another protocol/format for a connection with the seller and perform the protocol/format transformation to properly bridge the connections.

For example, the seller may use an instant messaging client of one instant messaging network and the customer may use an instant messaging client of another network. The system may use instant messaging clients of the respective networks to make connections with the customer and the seller and relay the messages to facilitate the communications between the customer and the seller.

For example, the seller may prefer to use email to receive text based communications and the customer may prefer to use SMS to receive responses; thus, the system provides a gateway for receiving text message from the customer via a web page (or SMS), sending the text message to the seller via email, receiving a response from the seller via email and sending the response to the customer via SMS.

For example, the seller may choose text-based instant messaging and the customer may choose voice-based instant messaging; and the system can receive the voice message from the customer, convert it into a text message (e.g., via a human operator or an automated voice recognition system), send the text message to the seller (with or without the confirmation of the customer), receive text response from seller, convert it into a voice response (e.g., via a human operator or an automated voice recognition system), and deliver the voice response to the customer.

For example, the seller may communicate in one language and the customer in another language. The system can perform translation (e.g., via a human translator and/or an automated translation system) while bridging the communication channels.

In one embodiment, the seller may offer different prices on different communication channels. For example, communications with the seller via phone connection, text-based instant messaging, application sharing, common whiteboarding, email, SMS, video-based instant messaging, etc., can have different prices.

Alternatively or in combination, the seller/communicatee may specify a set of offers based on media types (e.g., text, image, voice, video) and based on whether or not the communication is in real time; the seller/communicatee can further specify the available connection channels (methods) for the transmission and/or reception of communications in these media types. One media type (e.g., text) may be facilitated via a number of media channels (e.g., email, SMS, instant messaging, etc.). Thus, based on a media connection request from the customer, the system can select one or more appropriate channels to reach the seller and best match the preferred communication channel selected by the customer; and the customer is charged according to the different prices specified by the seller/communicatee.

In one embodiment, when there is a queue of customers waiting to be connected to the seller/communicatee, the customers may also increase the bid prices over the prices specified by the seller/communicate to improve their positions in the queue.

In one embodiment, the customer can select a combination of desired media types (e.g., text, image, voice/audio, video, etc.) and the mode of the connections for the selected media types (e.g., real time communications or non-real time communications). The system then prompts the customer to specify the connection methods/channels to facilitate communications in the selected media types. For example, the customer may select to have a voice connection via a callback to PSTN phone numbers, VoIP telephony, or instant messaging, or via voice mail, multimedia message, etc.). A call graphic can be presented to help the customer step by step through the selection/connection process.

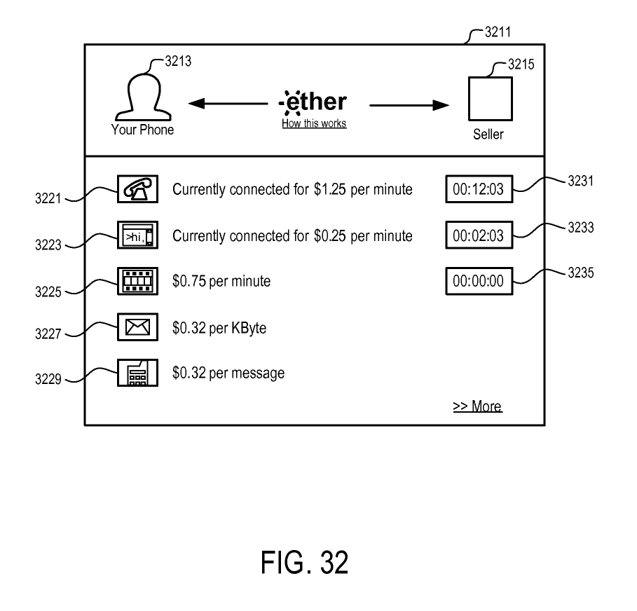

FIG. 32 illustrates a call graphic that allows a user to monitor concurrent connections according to one embodiment. In FIG. 32, the call graphic (3211) shows a representation of the customer (3213), a representation of the seller (3215), and the statuses of various connections.

In FIG. 32, the voice connection (3221) and the instant messaging connection (3223) are currently maintained for real time communications. The durations of the connections are shown in text boxes (3231 and 1063) respectively. The durations for the separate connections are separately tracked. In one embodiment, the voice connection (3221) and the instant messaging connection (3223) can be provided concurrently at least for a period of time.

In one embodiment, the customer can select the icons (3221 and 1053) to terminate the respective connections for voice and instant messaging. Alternatively or in combination, the customer can terminate the connections for voice and instant messaging separately without using the call graphic (3211). For example, the customer can hang up the phone to disconnect the voice connection, or close an instant messaging session to stop the voice connection and the instant messaging connection. In another embodiment, separate stop buttons (not shown in FIG. 32) are provided, which can be used to terminate the respective connections separately.

In FIG. 32, the customer can select the video icon (3225) to request a concurrent video connection, while the voice connection and instant messaging connection are maintained. The customer can select the email icon (3227) to request an email connection to the seller, the SMS icon (3229) for an SMS connection to the seller, etc.

As illustrated FIG. 32, different connections may have different prices. For example, the real time communication connections may be priced based on the time duration of the communication connections; and the non-real time communication connections may be priced based on the size of the communications. For example, email connections may be charged based on the size of the email messages; and the SMS connections may be charged based on the number of messages transmitted.

In one embodiment, the call graphic can further present the amounts that have been spent on the respective communication connections in the session and/or the total amount that has been spent on the communication connections in the session (not illustrated in FIG. 32).

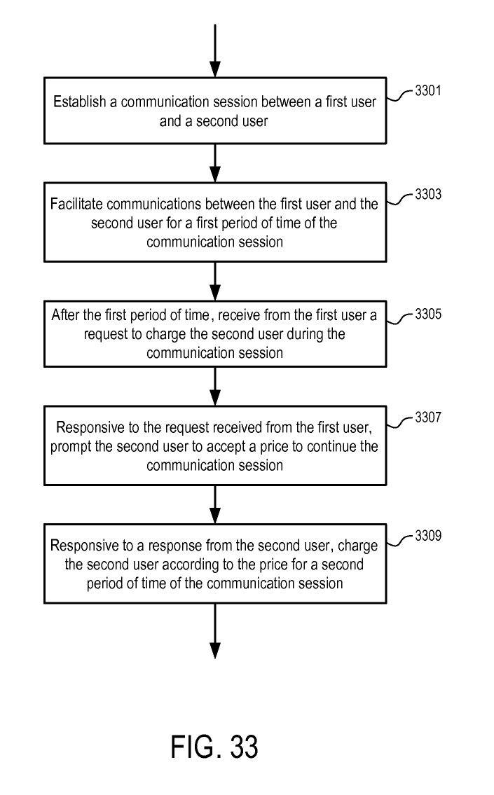

FIG. 33 illustrates a method to facilitate commerce over communication connections according to one embodiment.

In FIG. 33, a communication session is established (3301) between a first user and a second user (e.g., via a connection provider bridging separate connections to the first and second users), which facilitates (3303) communications between the first user and the second user for a first period of time of the communication session. After the first period of time, a request to charge the second user is received (3305) from the first user during the communication session. Responsive to the request received from the first user, the second user is prompted (3307) to accept a price to continue the communication session. Responsive to an acceptance response from the second user, the second user is charged (3309) according to the price for a second period of time of the communication session.

In one embodiment, the second user is not charged by the first user for the first period of time of the communication session; and the first user is compensated using a payment charged to the second user according to the price.

In one embodiment, during the first period of time, a first connection for communications of a first type between the first user and the second user is provided; and responsive a request received from the second user during the first period of time, a second connection for communications of a second type between the first user and the second user is provided. The second connection may be provided in addition to the first connection, or to replace the first connection. In one embodiment, the first type and the second type are different ones of text chat, voice chat, video conferencing, application sharing, common whiteboarding, and screen sharing.

In one embodiment, a connection provider receiving the request from the first user via a web interface while the connection provider provides a connection for real time communications between the first user and the second user, such as a telephone connection. In response to the request, the connection provider prompts the second user to accept the price.

In one embodiment, a communication reference is provided to represent the first user; a request for the communication session is received from the second user via the communication reference and presented to the first user; and the communication session is established in response to the first user accepting the second user's request for the communication session. In one embodiment, the communication reference includes a link to an icon; and the communication reference is to be embedded in a web page of the first user.

In one embodiment, a list of users who have requested communication sessions with the first user via the communication reference is presented to the first user; after the first user selects the second user from the list of users and selects a first connection type, the communication session is established according to the first connection type selected by the first user. In one embodiment, the communication session is dynamically upgradeable from the first connection type to a second connection type in response to a request from the second user.

In one embodiment, a user interface is presented to allow the second user to select a combination of connection types; and the communication session can be adjusted to facilitate the combination of connection types selected by the second user during the communication session.

In one embodiment, the first period of time includes at least 1) a first portion for text based real time conversation between the first user and the second user and 2) a second portion for voice based real time conversation between the first user and the second user.

In one embodiment, the communication session supports real time, in person communications between the first user and the second user. The communication session supports multimedia communications between the first user and the second user; and a plurality of media connections for the communication session are dynamically selectable during the communication session.

In one embodiment, responsive to an input from the first user, an offer of the first user is presented to the second user using a communication connection of the communication session; and it is then determined whether the second user accepts the offer. In one embodiment, the offer is not presented to the second user prior to the communication session. For example, the offer may be negotiated by the buyer and the seller during the communication session. In one embodiment, the offer includes a service delivered at least in part via the communication session, such as information, amusement, entertainment, advice, etc.

In general, routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention.

While some embodiments of the invention have been described in the context of fully functioning computers and computer systems, those skilled in the art will appreciate that various embodiments of the invention are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Thus, a method and system for deterring counterfeits have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
establishing a communication session between a first user and a second user;
facilitating communications between the first user and the second user for a first period of time of the communication session;
after the first period of time, receiving from the first user a request to charge the second user during the communication session;
responsive to the request received from the first user, prompting the second user to accept a price to continue the communication session; and
responsive to a response from the second user, charging the second user according to the price for a second period of time of the communication session.

2. The method of claim 1, wherein the second user is not charged by the first user for the first period of time of the communication session.

3. The method of claim 2, further comprising:
compensating the first user using a payment charged to the second user according to the price.

4. The method of claim 1, further comprising, during the first period of time:
providing a first connection for communications of a first type between the first user and the second user; and
responsive a request from the second user, providing a second connection for communications of a second type between the first user and the second user.

5. The method of claim 4, wherein the first type and the second type are different ones of text chat, voice chat, video conferencing, application sharing, common whiteboarding, and screen sharing.

6. The method of claim 1, wherein the receiving the request from the first user comprises a connection provider receiving the request from the first user via a web interface while the connection provider provides a connection for real time communications between the first user and the second user.

7. The method of claim 6, wherein the connection for real time communications comprises a telephone connection.

8. The method of claim 1, further comprising:
providing a communication reference to represent the first user;
via the communication reference, receiving a request for the communication session from the second user; and
presenting the request for the communication session to the first user;
wherein the communication session is established in response to the first user accepting the request for the communication session from the second user.

9. The method of claim 8, wherein the communication reference comprises a link to an icon; and the communication reference is to be embedded in a web page of the first user.

10. The method of claim 8, further comprising:
presenting a list of users who request communication sessions with the first user via the communication reference;
receiving from the first user a selection of the second user from the list of users; and
receiving a selection of a first connection type from the first user;
wherein the communication session is established according to the first connection type selected by the first user.

11. The method of claim 10, further comprising:
responsive to a request from the second user, upgrading the communication session from the first connection type to a second connection type.

12. The method of claim 1, further comprising:
presenting a user interface to allow the second user to select a combination of connection types;
adjusting the communication session to facilitate the combination of connection types selected by the second user during the communication session.

13. The method of claim 1, wherein the first period of time comprises at least a first portion for text based real time conversation between the first user and the second user and a second portion for voice based real time conversation between the first user and the second user.

14. The method of claim 1, wherein the communication session supports real time, in person communications between the first user and the second user.

15. The method of claim 1, wherein the communication session supports multimedia communications between the first user and the second user; and a plurality of media connections for the communication session are dynamically selectable during the communication session.

16. The method of claim 1, further comprising:
responsive to an input from the first user, presenting an offer of the first user to the second user using a communication connection of the communication session; and
determining whether the second user accepts the offer.

17. The method of claim 16, wherein the offer is not presented to the second user prior to the communication session.

18. The method of claim 16, wherein the offer includes a service delivered at least in part via the communication session.

19. A machine readable medium containing instructions which when executed on a data processing system cause the system to perform a method, comprising:
establishing a communication session between a first user and a second user;
facilitating communications between the first user and the second user for a first period of time of the communication session;
after the first period of time, receiving from the first user a request to charge the second user during the communication session;
responsive to the request received from the first user, prompting the second user to accept a price to continue the communication session; and
responsive to a response from the second user, charging the second user according to the price for a second period of time of the communication session.

20. A data processing system, comprising:
means for establishing a communication session between a first user and a second user;
means for facilitating communications between the first user and the second user for a first period of time of the communication session;
means for, after the first period of time, receiving from the first user a request to charge the second user during the communication session;
means for, responsive to the request received from the first user, prompting the second user to accept a price to continue the communication session; and
means for, responsive to a response from the second user, charging the second user according to the price for a second period of time of the communication session.
